(19) United States
(12) Patent Application Publication
(10) Pub. No.: US 2026/0172903 A1
(43) Pub. Date: Jun. 18, 2026

(54) SINGLE STREAM MEDIA CONNECTION FROM AN ACCESS POINT FOR MULTIPLE DEVICES

(71) Applicant: QUALCOMM Incorporated, San Diego, CA (US)

(72) Inventors: Ahmed Ragab ELSHERIF, San Jose, CA (US); Richard CARDOE, Fen Drayton (GB); Laurent WOJCIESZAK, Belfast (GB); Mayank BATRA, Cambridge (GB); John TURNER, Ely (GB)

(21) Appl. No.: 18/980,605

(22) Filed: Dec. 13, 2024

(51) Int. Cl. H04W 28/10; H04L 65/612; H04W 52/02

(52) U.S. Cl. CPC H04W 28/10; H04L 65/612; H04W 52/0229

(57) ABSTRACT

Various aspects of the present disclosure relate to wireless communication. In some aspects, a first device may transmit a medium access control (MAC) address of the first device and an internet protocol (IP) address of the first device to a second device paired with the first device. The first device may transmit a connection request to an application server on a non-cellular link via an access point, using the MAC address and the IP address. The first device may receive (and the second device may sniff) a set of media packets from the application server, via the access point, that are destined for the MAC address and the IP address. The first device may receive, from the second device, a request for media packets of the set of media packets. The first device may transmit, to the second device, buffered media packets of the media packets. Other aspects are described.

### FIELD OF THE DISCLOSURE

Aspects of the present disclosure generally relate to wireless communication and to techniques and apparatuses associated with a single stream media connection from an access point.

### BACKGROUND

A wireless personal area network (WPAN) is a short-range wireless network typically established by a user to interconnect various personal devices, sensors, and/or appliances located within a certain distance or area of the user. For example, a WPAN based on a communication protocol such as a Bluetooth® (BT) protocol, a Bluetooth Low Energy (BLE) protocol, or a Zigbee® protocol may provide wireless connectivity to peripheral devices that are within a specific distance (e.g., 5 meters, 10 meters, 20 meters, 100 meters) of each other. Bluetooth is a short-range wireless communication protocol that supports a WPAN between a central device (such as a host device or a source device) and at least one peripheral device (such as a client device or a sink device). However, power consumption associated with Bluetooth communications that operate on a basic rate (BR) and/or enhanced data rate (EDR) physical layer may render WPAN communication impractical in certain applications.

Accordingly, to address the power consumption challenges associated with Bluetooth BR/EDR (sometimes referred to as a Bluetooth classic or Bluetooth legacy protocol), BLE (also referred to herein as WPAN low energy (LE)) was developed and adopted in various applications in which data transfers are relatively infrequent and/or to enable WPAN communication with low power consumption. For example, BLE exploits infrequent data transfer by using a low duty cycle operation and placing one or both of the central device and the peripheral device(s) into a sleep mode between data transmissions, thereby conserving power. Example applications that use BLE include battery-operated sensors and actuators in various medical, industrial, consumer, and fitness applications. BLE may also be used to connect devices such as BLE-enabled smartphones, tablets, laptops, earbuds, or the like. While traditional (or classic) Bluetooth and BLE offer certain advantages, there exists a need for further improvements in Bluetooth and BLE technology. For example, traditional Bluetooth and BLE have a limited range, have a limited data capacity throughput, and are susceptible to interference from other devices communicating in the same frequency band (such as via wireless local area network (WLAN) communications).

### SUMMARY

Some aspects described herein relate to a method of wireless communication performed by a first device. The method may include transmitting a medium access control (MAC) address of the first device and an internet protocol (IP) address of the first device to a second device paired with the first device. The method may include transmitting a connection request to an application server on a non-cellular link via an access point, using the MAC address and the IP address. The method may include receiving a set of media packets from the application server, via the access point, that are destined for the MAC address and the IP address. The method may include receiving, from the second device, a request for one or more media packets of the set of media packets. The method may include transmitting, to the second device, one or more buffered media packets of the one or more media packets.

Some aspects described herein relate to a method of wireless communication performed by a second device. The method may include receiving, from a first device paired with the second device, a MAC address of the first device and an IP address of the first device. The method may include receiving, via an access point, a set of media packets with a destination of the MAC address and the IP address of the first device. The method may include transmitting, to the first device, a request for one or more media packets of the set of media packets that are not received by the second device. The method may include receiving, from the first device, one or more buffered media packets of the one or more media packets.

Some aspects described herein relate to an apparatus for wireless communication at a second device. The apparatus may include one or more memories and one or more processors coupled to the one or more memories. The one or more processors may be individually or collectively configured to transmit a MAC address of the first device and an IP address of the first device to a second device paired with the first device. The one or more processors may be individually or collectively configured to transmit a connection request to an application server on a non-cellular link via an access point, using the MAC address and the IP address. The one or more processors may be individually or collectively configured to receive a set of media packets from the application server, via the access point, that are destined for the MAC address and the IP address. The one or more processors may be individually or collectively configured to receive, from the second device, a request for one or more media packets of the set of media packets. The one or more processors may be individually or collectively configured to transmit, to the second device, one or more buffered media packets of the one or more media packets.

Some aspects described herein relate to an apparatus for wireless communication at a second device. The apparatus may include one or more memories and one or more processors coupled to the one or more memories. The one or more processors may be individually or collectively configured to receive, from a first device paired with the second device, a MAC address of the first device and an IP address of the first device. The one or more processors may be individually or collectively configured to receive, via an access point, a set of media packets with a destination of the MAC address and the IP address of the first device. The one or more processors may be individually or collectively configured to transmit, to the first device, a request for one or more media packets of the set of media packets that are not received by the second device. The one or more processors may be individually or collectively configured to receive, from the first device, one or more buffered media packets of the one or more media packets.

Some aspects described herein relate to a non-transitory computer-readable medium that stores a set of instructions for wireless communication by a first device. The set of instructions, when executed by one or more processors of the first device, may cause the first device to transmit a MAC address of the first device and an IP address of the first device to a second device paired with the first device. The set of instructions, when executed by one or more processors of the first device, may cause the first device to transmit a connection request to an application server on a non-cellular link via an access point, using the MAC address and the IP address. The set of instructions, when executed by one or more processors of the first device, may cause the first device to receive a set of media packets from the application server, via the access point, that are destined for the MAC address and the IP address. The set of instructions, when executed by one or more processors of the first device, may cause the first device to receive, from the second device, a request for one or more media packets of the set of media packets. The set of instructions, when executed by one or more processors of the first device, may cause the first device to transmit, to the second device, one or more buffered media packets of the one or more media packets.

Some aspects described herein relate to a non-transitory computer-readable medium that stores a set of instructions for wireless communication by a second device. The set of instructions, when executed by one or more processors of the second device, may cause the second device to receive, from a first device paired with the second device, a MAC address of the first device and an IP address of the first device. The set of instructions, when executed by one or more processors of the second device, may cause the second device to receive, via an access point, a set of media packets with a destination of the MAC address and the IP address of the first device. The set of instructions, when executed by one or more processors of the second device, may cause the second device to transmit, to the first device, a request for one or more media packets of the set of media packets that are not received by the second device. The set of instructions, when executed by one or more processors of the second device, may cause the second device to receive, from the first device, one or more buffered media packets of the one or more media packets.

Some aspects described herein relate to an apparatus for wireless communication. The apparatus may include means for transmitting a MAC address of the apparatus and an IP address of the apparatus to another apparatus paired with the apparatus. The apparatus may include means for transmitting a connection request to an application server on a non-cellular link via an access point, using the MAC address and the IP address. The apparatus may include means for receiving a set of media packets from the application server, via the access point, that are destined for the MAC address and the IP address. The apparatus may include means for receiving, from the other apparatus, a request for one or more media packets of the set of media packets. The apparatus may include means for transmitting, to the other apparatus, one or more buffered media packets of the one or more media packets.

Some aspects described herein relate to an apparatus for wireless communication. The apparatus may include means for receiving, from another apparatus paired with the apparatus, a MAC address of the other apparatus and an IP address of the other apparatus. The apparatus may include means for receiving, via an access point, a set of media packets with a destination of the MAC address and the IP address of the other apparatus. The apparatus may include means for transmitting, to the other apparatus, a request for one or more media packets of the set of media packets that are not received by the apparatus. The apparatus may include means for receiving, from the other apparatus, one or more buffered media packets of the one or more media packets.

Aspects generally include a method, apparatus, system, computer program product, non-transitory computer-readable medium, user equipment, base station, network entity, network node, central device, peripheral device, wireless communication device, access point, mobile station, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless personal area network (WPAN), in accordance with the present disclosure.

FIG. 2 is a diagram illustrating an example of a wireless communication device, in accordance with the present disclosure.

FIG. 3 is a diagram illustrating an example of a protocol stack, in accordance with the present disclosure.

FIG. 4 is a diagram illustrating an example transmission of a data packet from a wireless communication device to a peripheral device over a WPAN connection, in accordance with the present disclosure.

FIG. 5 is a diagram illustrating an example of a wireless communication device, in accordance with the present disclosure.

FIG. 6 is a diagram illustrating examples of a direct-to-cloud system, in accordance with the present disclosure.

FIGS. 7A and 7B are diagrams illustrating examples of a single stream Wi-Fi connection for paired devices, in accordance with the present disclosure.

FIGS. 8A and 8B are diagrams illustrating examples of a single stream Wi-Fi connection for paired devices, in accordance with the present disclosure.

FIG. 9 is a diagram illustrating examples of relay link, in accordance with the present disclosure.

FIG. 10 is a diagram illustrating an example of characteristics of solutions, in accordance with the present disclosure.

FIG. 11 is a diagram illustrating an example of a single stream connection to the cloud from paired devices, in accordance with the present disclosure.

FIG. 12 is a diagram illustrating an example of a single stream connection to the cloud from paired devices, in accordance with the present disclosure.

FIG. 13 is a diagram illustrating an example process performed, for example, at a first device or an apparatus of a first device, in accordance with the present disclosure.

FIG. 14 is a diagram illustrating an example process performed, for example, at a second device or an apparatus of a second device, in accordance with the present disclosure.

FIG. 15 is a diagram of an example apparatus for wireless communication, in accordance with the present disclosure.

FIG. 16 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless personal area network (WPAN), such as a Bluetooth® (BT) network or a Bluetooth Low Energy (BLE) network, a wireless device (e.g., a handset, a smartphone, or other user equipment (UE)) may connect to multiple peripheral devices (e.g., an earbud, an extended reality (XR) headset, a watch). When the wireless device powers on, the wireless device may initialize both basic rate enhanced data rate (BREDR) modules for connections with BREDR devices and BLE modules for connections with BLE devices. Modules may include a section of code that is part of a software program and that performs a particular function, such as handling a connection with a peripheral device.

In many scenarios, a peripheral or personal device, such as earbuds, are connected to a companion device, such as a UE (e.g., phone, laptop), which is connected to an application server. The music or audio from the application server passes through the UE. However, in other scenarios, personal devices may have direct internet access with wireless connectivity, without dependency on a companion device. The personal devices may be built on internet protocol (IP)-addressable and networkable audio products (e.g., earbuds/XR glasses) using low power Wi-Fi chips. The earbuds or glasses may connect to the application server via a Wi-Fi access point.

A dual stream connection for left and right earbuds that each have a Wi-Fi chip (two Wi-Fi clients with two distinct MAC addresses). However, audio synchronization streams from the application server would not typically contain timing information, the bandwidth would double with two independent devices, and the applications server would typically send stereo packets. The application server would see two independent devices that use the same account/credentials, and there would be duplicate device identification and duplicate session authorization. As a result, more signaling resources are consumed than necessary.

Various aspects relate generally to wireless device connections. Some aspects more specifically relate to a pair of personal devices (e.g., two earbuds, two temple components of an XR glass) that have a single stream Wi-Fi connection directly to the cloud with selective relay. A primary earbud (P-EB) may share its medium access control (MAC) and IP addresses with a secondary earbud (S-EB) over a peer link. The P-EB connects to the access point (AP) with a single MAC/IP address. The P-EB initiates connection to the application server, where only a single MAC/IP address is seen by the AP/cloud (only one earbud has a Wi-Fi chip). The audio stream may be sent to the common MAC/IP address. The P-EB receives and acknowledges the data from the AP. The S-EB operates in a sniffer mode, listening to packets destined to the common MAC/IP address. The S-EB communicates missed packets to the P-EB, and the P-EB selectively relays missed packets to the S-EB over the peer link.

Particular aspects of the subject matter described in this disclosure can be implemented to realize one or more of the following potential advantages. By presenting a single MAC/IP address to the cloud for paired devices, the paired devices may conserve signaling resources.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

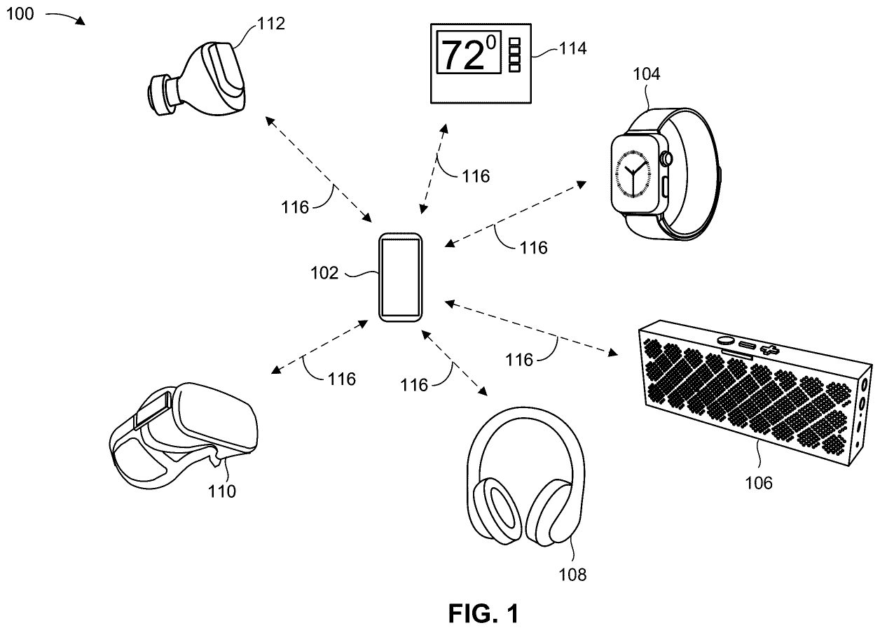

FIG. 1 is a diagram illustrating an example of a WPAN 100, according to some implementations. Within the WPAN 100, a central device 102 (which may be referred to herein as a source device or using other suitable terminology) may connect to and may establish a communication link 116 with one or more peripheral devices, such as a smartwatch 104, a Bluetooth portable speaker 106, wireless headphones 108, an XR headset 110, a wireless earbud 112, and/or a smart appliance 114 (which may be referred to herein as sink devices or using other suitable terminology) using a BLE protocol or a modified BLE protocol. The BLE protocol is part of the BT core specification and enables radio frequency communication operating within the globally accepted 2.4 GHz Industrial, Scientific, and Medical (ISM) band.

In some aspects, as described herein, the central device 102 may include suitable logic, circuitry, interfaces, processors, and/or code that may be used to communicate with the one or more peripheral devices 104, 106, 108, 110, 112, and/or 114 using the BLE protocol or the modified BLE protocol. In some aspects, the central device 102 may operate as an initiator to request establishment of a link layer (LL) connection with an intended peripheral device 104, 106, 108, 110, 112, and/or 114. In some aspects, a link manager may be used to control operations between a WPAN application controller in the central device 102 and a WPAN application controller in each of the intended peripheral devices 104, 106, 108, 110, 112, and/or 114.

In some aspects, after a requested LL connection is established, the central device 102 may become a host device, and the selected or intended peripheral device 104, 106, 108, 110, 112, and/or 114 may become paired with the central device 102 over the established LL connection. As a host device, the central device 102 may support multiple concurrent LL connections with various peripheral devices 104, 106, 108, 110, 112, and/or 114 that are operating as client devices. For example, the central device 102 may manage various aspects of data packet communication in an LL connection with one or more associated peripheral devices 104, 106, 108, 110, 112, and/or 114. For example, the central device 102 may determine an operation schedule in the LL connection with one or more peripheral devices 104, 106, 108, 110, 112, and/or 114. The central device 102 may also initiate an LL protocol data unit (PDU) exchange sequence over the LL connection. LL connections may be configured to run periodic connection events in dedicated data channels. The exchange of LL data PDU transmissions between the central device 102 and one or more of the peripheral devices 104, 106, 108, 110, 112, and/or 114 may take place within connection events.

In some aspects, the central device 102 may be configured to transmit the first LL data PDU in each connection event to an intended peripheral device 104, 106, 108, 110, 112, and/or 114. Additionally, or alternatively, in some aspects, the central device 102 may utilize a polling scheme to poll the intended peripheral device 104, 106, 108, 110, 112, and/or 114 for an LL data PDU transmission during a connection event. The intended peripheral device 104, 106, 108, 110, 112, and/or 114 may transmit an LL data PDU upon receipt of a packet carrying an LL data PDU from the central device 102. In some other aspects, a peripheral device 104, 106, 108, 110, 112, and/or 114 may transmit an LL data PDU to the central device 102 without first receiving an LL data PDU from the central device 102.

Examples of the central device 102 may include a cellular phone, a smartphone, a session initiation protocol (SIP) phone, a mobile station (STA), a laptop, a personal computer (PC), a desktop computer, a personal digital assistant (PDA), a satellite radio, a global positioning system, a multimedia device, a video device, a digital audio player, a camera, a game console, a tablet, a smart device, a wearable device (such as a smart watch or wireless headphones), a vehicle, a vehicle infotainment system or car kit, an electric meter, a gas pump, a toaster, a thermostat, a hearing aid, a blood glucose on-body unit, an Internet-of-Things (IoT) device, or the like.

Examples of the one or more peripheral devices 104, 106, 108, 110, 112, and/or 114 may include a cellular phone, a smartphone, an SIP phone, an STA, a laptop, a PC, a desktop computer, a PDA, a satellite radio, a global positioning system, a multimedia device, a video device, a digital audio player, a camera, a game console, a tablet, a smart device, a wearable device (e.g., a smart watch, wireless headphones, or wireless earbuds), a vehicle, a vehicle infotainment system or car kit, an electric meter, a gas pump, a toaster, a thermostat, a hearing aid, a blood glucose on-body unit, an IoT device, or the like. Although the central device 102 is illustrated in FIG. 1 as being in communication with six peripheral devices 104, 106, 108, 110, 112, and 114 in the WPAN 100, the central device 102 may communicate with more or fewer than six peripheral devices within the WPAN 100 without departing from the scope of the present disclosure.

In some aspects, a device implementing the BT protocol (e.g., the central device 102) may operate according to a first radio mode (e.g., a basic rate (BR)/enhanced data rate (EDR) radio mode), and a device implementing the BLE protocol may operate according to a second radio mode (e.g., the BLE radio mode). In some aspects, the central device 102 may be configured with dual radio modes, and therefore may be able to operate according to the BR/EDR mode or the BLE mode, for example, based on the type of short-range wireless communication in which the central device 102 may engage.

For example, in some aspects, the central device 102 may operate according to the BR/EDR mode for continuous streaming of data, for broadcast networks, for mesh networks, and/or for some other applications in which a relatively higher data rate may be more suitable. Additionally, or alternatively, the central device 102 may operate according to the BLE mode for short burst data transmissions, such as for some other applications in which power conservation may be desirable and/or a relatively lower data rate may be acceptable. Additionally, or alternatively, in some aspects, the central device 102 may operate according to one or more other radio modes, such as proprietary radio mode(s). Examples of other radio modes may include high speed radio modes, low energy radio modes, and/or isochronous radio modes, among other examples.

In some aspects, as described in more detail elsewhere herein, an assisting wireless device (e.g., among peripheral devices 104, 106, 108, 110, 112, and 114) may track a first retransmission metric that is based on a number of retransmitted packets that the assisting wireless device received from a source device, such as the central device 102. The assisting wireless device may receive, from a sink wireless device (e.g., among peripheral devices 104, 106, 108, 110, 112, and 114), an acknowledgement assistance request indicating a second retransmission metric for the sink wireless device. The assisting wireless device may transmit, to the sink wireless device, a response to the acknowledgement assistance request based on respective values of the first retransmission metric and the second retransmission metric. Additionally, or alternatively, the assisting wireless device may perform one or more other operations described herein.

In some aspects, as described in more detail elsewhere herein, a sink wireless device (e.g., among peripheral devices 104, 106, 108, 110, 112, and 114) may track a first retransmission metric that is based on a number of retransmitted packets that the sink wireless device received from a source device, such as the central device 102. The sink wireless device may transmit, to an assisting wireless device (e.g., among peripheral devices 104, 106, 108, 110, 112, and 114), an acknowledgement assistance request indicating the first retransmission metric tracked by the sink wireless device. The sink wireless device may receive, from the assisting wireless device, a response to the acknowledgement assistance request based on respective values of the first retransmission metric tracked by the sink wireless device and a second retransmission metric tracked by the assisting wireless device. Additionally, or alternatively, the sink wireless device may perform one or more other operations described herein.

As indicated above, FIG. 1 is provided as an example. Other examples may differ from what is described with regard to FIG. 1.

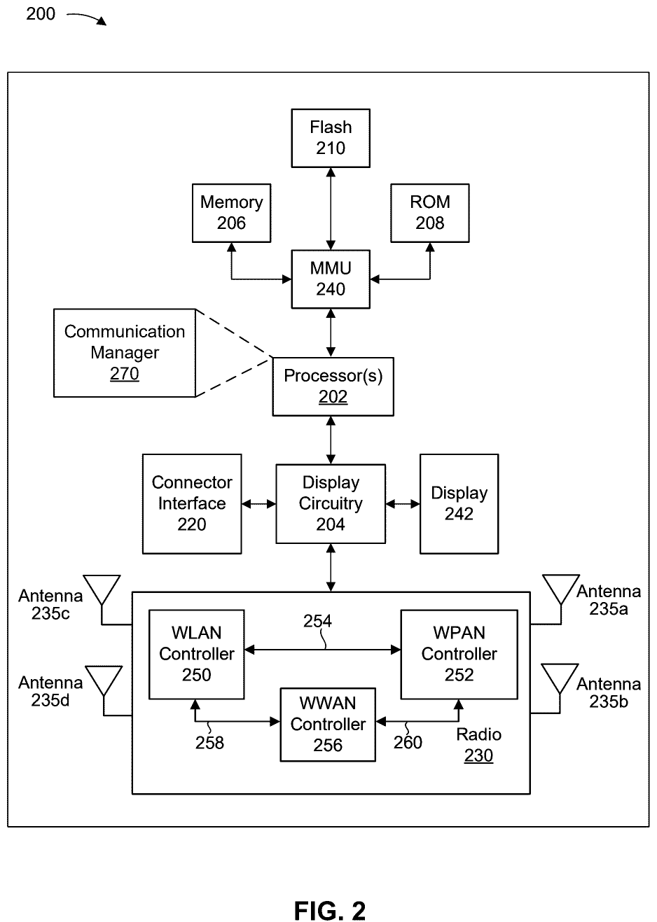

FIG. 2 is a diagram illustrating an example of a wireless communication device 200, in accordance with the present disclosure. In some aspects, the wireless communication device 200 may be an example of the central device 102 illustrated in FIG. 1. Additionally, or alternatively, the wireless communication device 200 may be an example of one or more of the peripheral devices 104, 106, 108, 110, 112, or 114 illustrated in FIG. 1. In some aspects, the wireless communication device 200 may be a Bluetooth-enabled device (such as a BLE device).

As shown in FIG. 2, the wireless communication device 200 may include a processing element, such as processor(s) 202, which may execute program instructions for the wireless communication device 200. The wireless communication device 200 may also include a display 242 that can perform graphics processing and present information to a user. The processor(s) 202 may also be coupled to a memory management unit (MMU) 240, which may be configured to receive addresses from the processor(s) 202 and translate the addresses to address locations in memory such as memory 206, ROM 208, or flash memory 210 and/or to address locations in other circuits or devices, such as display circuitry 204, radio 230, connector interface 220, and/or display 242. The MMU 240 may also be configured to perform memory protection and page table translation or set up. In some aspects, the MMU 240 may be included as a portion of the processor(s) 202.

The processor(s) 202 may be coupled to other circuits of the wireless communication device 200. For example, the wireless communication device 200 may include various memory types, a connector interface 220 through which the wireless communication device 200 can communicate with a computer system, and wireless communication subsystems that can transmit data to, and receive data from, other devices based on one or more wireless communication standards or protocols. For example, in some aspects, the wireless communication subsystems may include (but are not limited to) a wireless local-area network (WLAN) subsystem, a WPAN subsystem, and/or a cellular subsystem (such as a Long-Term Evolution (LTE) or New Radio (NR) subsystem). The wireless communication device 200 may include multiple antennas 235a, 235b, 235c, and/or 235d for performing wireless communication with, for example, wireless communication devices in a WPAN. In some aspects, the WPAN may be an extended PAN (XPAN).

The wireless communication device 200 may be configured to implement part or all of the techniques described herein by executing program instructions stored on a memory medium (such as a non-transitory computer-readable memory medium) and/or through hardware or firmware operation. In other embodiments, the techniques described herein may be at least partially implemented by a programmable hardware element, such as an FPGA, and/or an application specific integrated circuit (ASIC).

In some aspects, the radio 230 may include separate controllers configured to control communications for various respective radio access technology (RAT) protocols. For example, as shown in FIG. 2, radio 230 may include a WLAN controller 250 that manages WLAN communications, a WPAN controller 252 that manages Bluetooth, BLE, and/or other suitable WPAN communications, and a wireless wide area network (WWAN) controller 256 that manages WWAN communications. In some aspects, the wireless communication device 200 may store and execute a WLAN software driver for controlling WLAN operations performed by the WLAN controller 250, a WPAN software driver for controlling WPAN operations performed by the WPAN controller 252, and/or a WWAN software driver for controlling WWAN operations performed by the WWAN controller 256.

In some aspects, a first coexistence interface 254 (such as a wired interface) may be used for sending information between the WLAN controller 250 and the WPAN controller 252. Additionally, or alternatively, in some aspects, a second coexistence interface 258 may be used for sending information between the WLAN controller 250 and the WWAN controller 256. Additionally, or alternatively, in some aspects, a third coexistence interface 260 may be used for sending information between the WPAN controller 252 and the WWAN controller 256.

In some aspects, one or more of the WLAN controller 250, the WPAN controller 252, and/or the WWAN controller 256 may be implemented as hardware, software, firmware, or any suitable combination thereof.

In some aspects, the WLAN controller 250 may be configured to communicate with a second device in a WPAN using a WLAN link using one or more, some, or all of the antennas 235a, 235b, 235c, and 235d. In other configurations, the WPAN controller 252 may be configured to communicate with at least one second device in a WPAN using one or more, some, or all of the antennas 235a, 235b, 235c, and 235d. In other configurations, the WWAN controller 256 may be configured to communicate with a second device in a WPAN using one or more, some, or all of the antennas 235a, 235b, 235c, and 235d. The WLAN controller 250, the WPAN controller 252, and/or the WWAN controller 256 may be configured to adjust a wakeup time interval and a shutdown time for the wireless communication device 200.

A short-range wireless communications protocol, such as BT, BLE, and/or BR/EDR, may include and/or may use one or more other communications protocols, for example, to establish and maintain communications links. Referring also to FIG. 1, the wireless communication device 200 may establish a communications link 116 with one or more peripheral devices, such as a wireless headset 110, according to at least one communications protocol for short-range wireless communications. In some aspects, the communications link 116 may include a communications link that adheres to a protocol included and/or for use with BT, BLE, BR/EDR, or the like. In one aspect, the communications link 116 may include an asynchronous connection-oriented logical (ACL) transport, sometimes referred to as an ACL link. When operating as an ACL link, the communications link 116 may allow the central device 102 (e.g., a source device) to connect or “pair” with a peripheral device, such as the headset 110. The connection is asynchronous in that the two devices may not need to synchronize, timewise, data communications between each other to permit communication of data packets via the communications link 116.

In some aspects, a logical link control and adaptation protocol (L2CAP) may be used within a BT protocol stack (not shown in FIG. 2 for simplicity). An L2CAP connection may be established after an ACL link has been established. Reference to L2CAP in the present disclosure may be further applicable to enhanced L2CAP (EL2CAP), which may be an enhanced version of the L2CAP protocol that enables multiplexing of multiple logical data channels via a single radio connection.

In some aspects, the communications link 116 may include an advanced audio distribution profile (A2DP) link. For example, an A2DP link may provide a point-to-point link between a source device, such as the central device 102, and a sink device, such as the headset 110. With an A2DP link, data packets including audio may be transmitted over an ACL channel, and other information (e.g., for controlling the audio stream) may be transmitted over a separate control channel. The data packets may occur non-periodically.

In some aspects, the communications link 116 may support synchronous logical transport mechanisms between a source device (such as the central device 102) and a peripheral device (such as the headset 110). For example, the communications link 116 may include a synchronous connection-oriented (SCO) link that provides a symmetric point-to-point link between the source device and the peripheral device using time slots reserved for BT communications. In some aspects, an SCO link may not support retransmission of data packets, which may be unsatisfactory in audio streaming and/or voice call use cases in which a dropped audio or voice packet may reduce the quality of the user experience.

In some aspects, the communications link 116 may include an extended SCO (eSCO) link. An eSCO link may provide a symmetric or asymmetric point-to-point link between a source device and a peripheral device using time slots reserved for BT communications, and may also provide for a retransmission window following the reserved time slots. Because retransmissions may be facilitated using the retransmission window, an eSCO link may be suitable for audio streaming and/or voice call use cases because a dropped audio or voice packet may be retransmitted, and therefore the probability of successfully receiving a data packet may be increased.

In some aspects, the communications link 116 shown in FIG. 1 may include an isochronous (ISO) link. When operating as an ISO link, the communications link 116 may combine some features of both synchronous and asynchronous links. For example, a stream on an ISO link may begin with a start packet, and then data packets may be asynchronously transmitted. On an ISO link, the number of retransmission attempts by a transmitting device may be limited. Thus, if a receiving device is unable to decode a data packet within the limited number of retransmission attempts, then the data packet may be dropped, and the receiving device may continue to receive the stream without data from the dropped data packet.

In some aspects, a first device (e.g., wireless communication device 200, a central device 102, a mobile station, a UE, a peripheral device 110) may include a communication manager 270. As described in more detail elsewhere herein, the communication manager 270 may transmit a MAC address of the first device and an IP address of the first device to a second device paired with the first device; transmit a connection request to an application server on a non-cellular link via an access point, using the MAC address and the IP address; receive a set of media packets from the application server, via the access point, that are destined for the MAC address and the IP address; receive, from the second device, a request for one or more media packets of the set of media packets; and transmit, to the second device, one or more buffered media packets of the one or more media packets. Additionally, or alternatively, the communication manager 270 may perform one or more other operations described herein.

In some aspects, a second device (e.g., wireless communication device 200, a central device 102, a mobile station, a UE, a peripheral device 110) may include a communication manager 270. As described in more detail elsewhere herein, the communication manager 270 may receive, from a first device paired with the second device, a MAC address of the first device and an IP address of the first device; receive, via an access point, a set of media packets with a destination of the MAC address and the IP address of the first device; transmit, to the first device, a request for one or more media packets of the set of media packets that are not received by the second device; and receive, from the first device, one or more buffered media packets of the one or more media packets. Additionally, or alternatively, the communication manager 270 may perform one or more other operations described herein.

In some aspects, a first device (e.g., wireless communication device 200, a central device 102, a mobile station, a UE, a peripheral device 110) includes means for transmitting a MAC address of the first device and an IP address of the first device to a second device paired with the first device; means for transmitting a connection request to an application server on a non-cellular link via an access point, using the MAC address and the IP address; means for receiving a set of media packets from the application server, via the access point, that are destined for the MAC address and the IP address; means for receiving, from the second device, a request for one or more media packets of the set of media packets; and/or means for transmitting, to the second device, one or more buffered media packets of the one or more media packets. In some aspects, the means for the wireless device to perform operations described herein may include, for example, one or more of a WPAN controller 252, memory 206, antenna 235, processor 202, and/or MMU 240.

In some aspects, a second device (e.g., wireless communication device 200, a central device 102, a mobile station, a UE, a peripheral device 110) includes means for receiving, from a first device paired with the second device, a MAC address of the first device and an IP address of the first device; means for receiving, via an access point, a set of media packets with a destination of the MAC address and the IP address of the first device; means for transmitting, to the first device, a request for one or more media packets of the set of media packets that are not received by the second device; and/or means for receiving, from the first device, one or more buffered media packets of the one or more media packets. In some aspects, the means for the wireless device to perform operations described herein may include, for example, one or more of a WPAN controller 252, memory 206, antenna 235, processor 202, and/or MMU 240.

As indicated above, FIG. 2 is provided as an example. Other examples may differ from what is described with regard to FIG. 2.

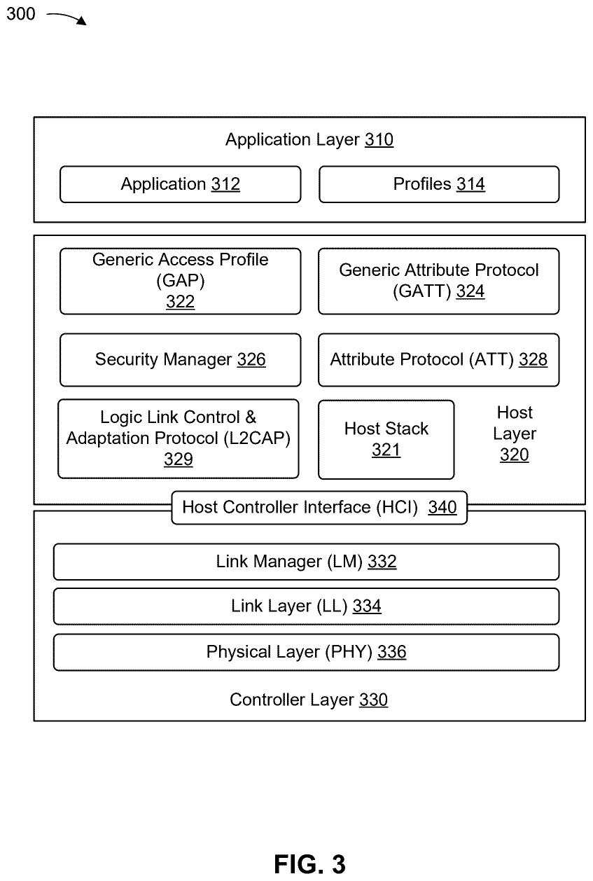

FIG. 3 is a diagram illustrating an example 300 of a protocol stack (e.g., a WPAN and/or a Bluetooth protocol stack), in accordance with the present disclosure. In some aspects, the protocol stack 300 may be implemented in a wireless communication device (such as the central device 102 or one or more of the peripheral devices 104, 106, 108, 110, 112, or 114 of FIG. 1). For example, the protocol stack 300 may be implemented by one or more of processor(s) 202, memory 206, flash memory 210, ROM 208, the radio 230, and/or the WPAN controller 252 illustrated in FIG. 2. In some aspects, the protocol stack 300 may be organized into three layers that include an application layer 310, a host layer 320, and a controller layer 330.

In some aspects, the application layer 310 may be a user application layer that interfaces with the other blocks and/or layers of the protocol stack 300. In some aspects, the application layer 310 may include one or more applications 312 and one or more Bluetooth profiles 314 that allow the one or more applications 312 to use Bluetooth and/or BLE communications. The host layer 320 may include the upper layers of the protocol stack 300, and may communicate with a controller (such as the WPAN controller 252 of FIG. 2) in a wireless communication device using a host controller interface (HCI) 340. In some aspects, the host layer 320 may include a host stack 321 that can be used for application layer interface management to allow an application 312 to access WPAN communications.

The controller layer 330 may include the lower layers of the protocol stack 300. In some aspects, the controller layer 330 may be used for hardware interface management, link establishment, and link management. As shown in FIG. 3, the controller layer 330 may include a link manager (LM) 332, a link layer 334, and a physical (PHY) layer 336. The PHY layer 336 may include, for example, a radio and/or a baseband processor. In some aspects, the PHY layer 336 may define a mechanism for transmitting a bit stream over a physical link or channel that connects WPAN devices. The bit stream may be grouped into code words or symbols, and may be converted to a data packet that is transmitted over a wireless transmission medium. The PHY layer 336 may provide an electrical, mechanical, and/or procedural interface to the wireless transmission medium. The PHY layer 336 may be responsible for modulation and demodulation of data into RF signals for transmission over the air. The PHY layer 336 may describe the physical characteristics of a transmitter/receiver (or transceiver) included in a wireless communication device. The physical characteristics may include modulation characteristics, an RF tolerance, and/or a sensitivity level, among other examples.

In some aspects, the link layer 334 is responsible for low-level communication over the PHY layer 336. The link layer 334 may manage the sequence and timing for transmitting and receiving data packets, and using an LL protocol, communicates with other devices regarding connection parameters and data flow control. The link layer 334 also provides gatekeeping functionality to limit exposure and data exchange with other devices. If filtering is configured, the link layer 334 maintains a list of allowed devices and may ignore all requests for data exchange from devices not on the list of allowed devices. The link layer 334 may also reduce power consumption. In some aspects, the link layer 334 may include a proprietary LL that may be used to discover peer devices and establish a secure communication channel with the peer devices. In some aspects, the link layer 334 may be responsible for transporting data packets between devices in a WPAN. Each data packet may include an access address, which specifies the type of logical transport used to carry the data packet. Logical transports may exist between a master device and slave devices. Additionally, some logical transports may carry multiple logical links.

The link manager 332 may be responsible for establishing and configuring links and managing power-change requests, among other tasks. Each type of logical link, such as ACL links, A2DP links, SCO links, eSCO links, ISO links, or the like, may be associated with a specific packet type. For example, an SCO link may provide reserved channel bandwidth for communication between a central device and a peripheral device, and may support regular, periodic exchange of data packets with no retransmissions. An eSCO link may provide reserved channel bandwidth for communication between a source device and a peripheral device, and support regular, periodic exchange of data packets with retransmissions. An ACL link may exist between a source device and a peripheral device from the beginning of establishment of a connection between the source device and the peripheral device, and the data packets for ACL links may include encoding information in addition to a payload.

The link manager 332 may communicate with the host layer 320 using the HCI 340. In some aspects, the link manager 332 may translate commands associated with the HCI 340 into controller-level operations, such as baseband-level operations. The HCI 340 may act as a boundary between the lower layers (such as between the controller layer 330, the host layer 320, and the application layer 310). The BT specification may define a standard HCI to support BT systems that are implemented across two separate processors. For example, a BT system on a computer may use a processor of the BT system to implement the lower layers of the protocol stack 300, such as the PHY layer 336, the link layer 334, and/or the link manager 332, and may use a processor of a BT component to implement the other layers of the protocol stack 300, such as the host layer 320 and the application layer 310.

In FIG. 3, the host layer 320 is shown to include a generic access profile (GAP) 322, a generic attribute protocol (GATT) 324, a security manager (SM) 326, an attribute protocol (ATT) 328, and an L2CAP layer 329. The GAP 322 may provide an interface for an application 312 to initiate, establish, and manage connections with other WPAN (e.g., BT or BLE) devices. The GATT 324 may provide a service framework using the attribute protocol for discovering services, and for reading and writing characteristic values on a peer device. The GATT 324 may interface with the application 312, for example, through a profile which may define a collection of attributes and any permissions needed for the attributes to be used in BT or BLE communications.

The security manager 326 may be responsible for device pairing and key distribution. A security manager protocol implemented by the security manager 326 may define how communications with the security manager of a counterpart BLE device are performed. The security manager 326 provides additional cryptographic functions that may be used by other components of the protocol stack 300. The architecture of the security manager 326 used in WPAN communications is designed to minimize recourse requirements for peripheral devices by shifting work to a presumably more powerful central device. BLE uses a pairing mechanism for key distribution. The security manager 326 provides a mechanism to encrypt the data and a mechanism to provide data authentication.

The ATT 328 includes a client/server protocol based on attributes associated with a BLE device configured for a particular purpose. Examples may include monitoring heart rate, temperature, broadcasting advertisements, or the like. The attributes may be discovered, read, and written by peer devices. The set of operations which are executed over the ATT 328 may include error handling, server configuration, find information, read operations, write operations, and/or queued writes. The ATT 328 may form the basis of data exchange between BT and BLE devices.

The L2CAP layer 329 may be implemented above the HCI 340, and may communicate with the controller layer 330 through the HCI 340. The L2CAP layer 329 may be responsible for establishing connections across one or more existing logical links and for requesting additional links if none exist. The L2CAP layer 329 may also implement multiplexing between different higher-layer protocols, for example, to allow different applications to use a single link, such as a logical link, including an ACL link. In some implementations, the L2CAP layer 329 may encapsulate multiple protocols from the upper layers into a data packet format (and vice versa). The L2CAP layer 329 may also break packets with a large data payload from the upper layers into multiple packets with the data payload segmented into smaller size data payloads that fit into a maximum payload size (for example, twenty-seven (27) bytes) on the transmit side.

In some standards and protocols, such as BLE and/or BR/EDR, the central device 102 may detect errors in a packet and/or a dropped/missed/not received packet through the use of cyclic redundancy check (CRC) validation and through the use of message integrity code (MIC) validation. MIC validation may be used when a packet is encrypted. For example, failure of CRC validation may indicate one or more errors in a received packet, and failure of MIC validation may indicate that another packet has not been received (although failure of CRC validation may also indicate that another packet has not been received, and/or failure of MIC validation may also indicate one or more errors in a received packet).

CRC validation and MIC validation may be based on generating CRC values and MICs, respectively, based on received packets and respectively comparing those generated CRC values and MICs to CRC values and MICs included in the received packets. Specifically, a receiving device, such as the headset 110, that receives a packet may first generate a CRC value or a CRC checksum based on the received packet, such as based on a payload and, if applicable, an MIC included in the received packet. The receiving device may compare the generated CRC value with a CRC value included in the received packet. If the generated CRC value matches the CRC value included in the received packet, then the received packet may be validated for CRC. The CRC-validated received packet may then be decrypted. However, if the generated CRC value does not match the CRC value included in the received packet, then the receiving device may determine that the received packet fails CRC validation. If the receiving device determines that the received packet fails CRC validation, then the received packet may include errors and/or may be corrupted. In one configuration, the receiving device may discard the received packet that fails CRC validation. Alternatively, in another configuration, the receiving device may attempt to recover the received packet, for example, using one or more error correction techniques.

If the received packet is encrypted and passes CRC validation, then the receiving device may decrypt the received packet to obtain a decrypted payload and a decrypted MIC. For MIC validation, the receiving device may generate an MIC based on the decrypted payload and compare the generated MIC with the MIC obtained from the decrypted received packet. If the generated MIC matches the decrypted MIC, then the receiving device may determine that the received packet is successfully decrypted. When the received packet is successfully decrypted, the decoded and decrypted payload of the received packet may be provided to another layer of the receiving device, such as a coder-decoder (codec) of the receiving device that may cause the payload data of the received packet to be output by the receiving device, for example, as audio through speakers of the headset 110.

If the generated MIC does not match the decrypted MIC of the received packet, then the receiving device may determine that the received packet is unsuccessfully decrypted. When the received packet is unsuccessfully decrypted, then a different packet may have been missed or the received packet may be erroneous or otherwise corrupted. In one configuration, the receiving device may discard the received packet that fails MIC validation. Alternatively, in another configuration, the receiving device may attempt to recover the received packet.

As indicated above, FIG. 3 is provided as an example. Other examples may differ from what is described with regard to FIG. 3.

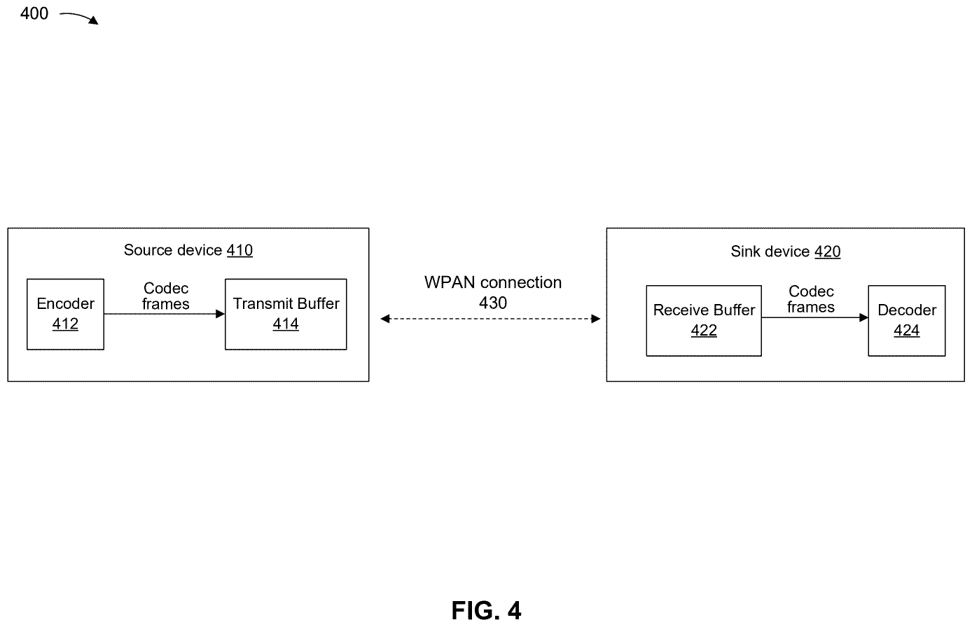

FIG. 4 is a diagram illustrating an example transmission 400 of a data packet from a source device 410 to a sink device 420 over a WPAN connection 430, according to the present disclosure. In some aspects, the source device 410 may be one example of the central device 102 in FIG. 1 and/or the wireless communication device 200 in FIG. 2, and the sink device 420 may be an example of one or more of the peripheral devices 104, 106, 108, 110, 112 or 114 in FIG. 1. In some aspects, the sink device 420 may be a wireless earbud, a pair of wireless earbuds, a wireless portable speaker, or another suitable device. The WPAN connection 430 may be any suitable Bluetooth or BLE connection or link. In some instances, the WPAN connection 430 may be one or more of an ACL link, an L2CAP link, an A2DP link, an SCO link, or an ISO link.

As shown in FIG. 4, the source device 410 may include an encoder 412 and a transmit buffer 414. The encoder 412 may be configured to encode data, such as audio or video data, using a specified bitrate. The transmit buffer 414 may be configured to queue data packets that are to be transmitted over the WPAN connection 430 to the sink device 420. In some implementations, the data packets to be transmitted over the WPAN connection 430 may have a predefined size, for example, based on the type of WPAN connection 430 and/or channel conditions associated with the WPAN connection 430. In some aspects, data encoded by the encoder 412 may be packetized into a data packet of a predefined size. The source device 410 may de-queue data packets from the transmit buffer 414 and transmit the data packets to the sink device 420 over the WPAN connection 430.

As further shown in FIG. 4, the sink device 420 may include a receive buffer 422 and a decoder 424. Data packets that the sink device 420 receives over the WPAN connection 430 may be queued or otherwise stored in the receive buffer 422. The data packets may be output from the receive buffer 422 and forwarded to the decoder 424. In some aspects, the decoder 424 may decode data (such as audio and/or video data) carried in the payloads of the queued data packets, and forward the decoded data to upper layers of the protocol stack for processing and playback to a user. In some implementations, the encoder 412 may encode a first encoder/decoder (codec) frame using a first bitrate and forward the first codec frame to the transmit buffer 414 to be packetized for transmission to the sink device 420 over the WPAN connection 430. The sink device 420 may queue the received data packet in the receive buffer 422 and may forward the first portion of the first codec frame to the decoder 424 for decoding.

As indicated above, FIG. 4 is provided as an example. Other examples may differ from what is described with regard to FIG. 4.

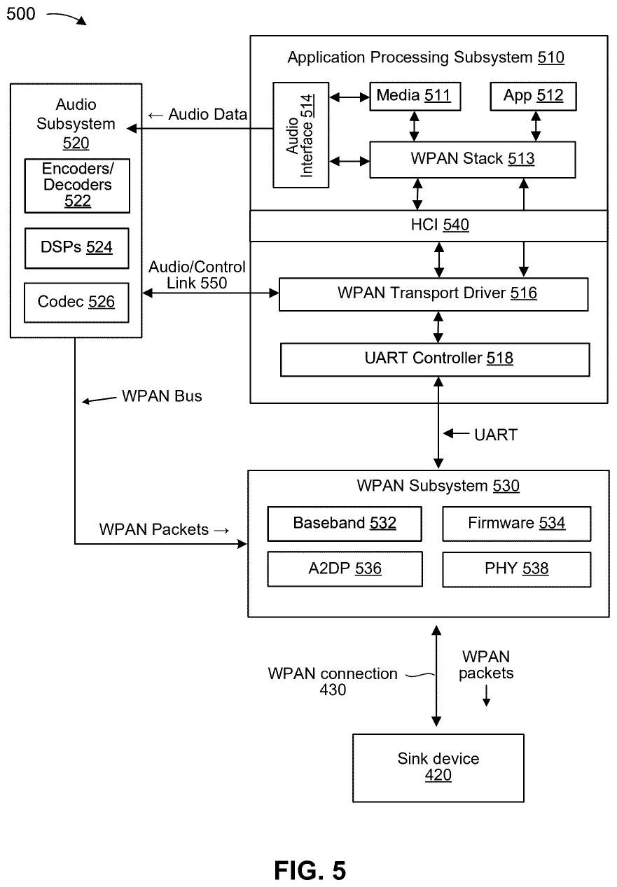

FIG. 5 is a diagram illustrating an example 500 of a wireless communication device 500, according to the present disclosure. In some aspects, the wireless communication device 500 may be an example of the central device 102 in FIG. 1, the wireless communication device 200 in FIG. 2, or the source device 410 in FIG. 4. In example 500, the wireless communication device 500 is depicted as having an established WPAN connection 430 (e.g., a Bluetooth communication connection) with the sink device 420 in FIG. 4.

The wireless communication device 500 may include an application processing subsystem 510, an audio subsystem 520, a WPAN subsystem 530, and an HCI 540. The application processing subsystem 510, which may correspond to at least some portions of the application layer 310 and the host layer 320 of the protocol stack 300 of FIG. 3, is shown to include a media player 511, an application layer 512, a WPAN stack 513, and an audio interface 514. The media player 511 can be any suitable device or component capable of generating or receiving multimedia content including, for example, real-time audio streams, real-time video streams, real-time gaming streams, and/or latency-sensitive traffic, among other examples. The application layer 512, which may be one implementation of the application layer 310 of FIG. 3, includes at least one Bluetooth profile that defines the collection of attributes and associated permissions to be used in Bluetooth or BLE communications. In some aspects, the application layer 512 may include processing resources including, for example, the memory 206, the ROM 208, and/or the flash memory 210 of FIG. 2. The WPAN stack 513 may be one implementation of the protocol stack 300 of FIG. 3.

In some aspects, as shown in FIG. 5, the application processing subsystem 510 may include a WPAN transport driver 516, which may include a split audio and packetization module (not shown for simplicity) that can packetize data (such as audio and/or video data) into Bluetooth frames that can be transmitted to the sink device 420 using a Bluetooth and/or BLE protocol. In some aspects, the WPAN transport driver 516 may be connected to the audio subsystem 520 via an audio and control link 550. In some aspects, the audio and control link 550 may be used to send encoded audio/video data and control signals between the WPAN transport driver 516 and audio/video DSPs within the audio subsystem 520. The WPAN transport driver 516 is also connected to a universal asynchronous receiver-transmitter (UART) controller 518 that provides controls for transmission of information via the WPAN connection 430.

The audio subsystem 520 may include encoders/decoders 522, one or more DSPs 524, and one or more codecs 526. The encoders/decoders 522 may be used to sample audio/video data extracted from one or more packets received from another wireless communication device. The extracted audio/video data may be processed in the application processing subsystem 510 based at least in part on the Bluetooth profile. In some implementations, the encoders/decoders 522 may partition the sampled audio/video data into payloads that can be embedded within one or more Bluetooth packets for transmission to the sink device 420 over the WPAN connection 430. In some instances, the DSPs 524 and/or the codecs 526 may employ one or more encoding or decoding algorithms in conjunction with sampling the audio data.

The WPAN subsystem 530 may include a baseband component 532 (e.g., a Bluetooth baseband component), a firmware component 534, an A2DP component 536, and a PHY component 538. The baseband component 532 and the firmware component 534 may be used to generate baseband signals for constructing and deconstructing data frames based on the Bluetooth or BLE protocol. The baseband component 532 and the firmware component 534 may also be used to generate carrier signals for up-converting baseband signals during data transmissions and for down-converting received data signals to baseband. The A2DP component 536 may be used to control or manage an A2DP link between the wireless communication device 500 and the sink device 420. Specifically, when the WPAN subsystem 530 is in a receive mode, the PHY component 538 can be used to receive, demodulate, and down-convert data packets received over the WPAN connection 430, and to forward the data packets to the application processing subsystem 510. When the WPAN subsystem 530 is in a transmit mode, the PHY component 538 can be used to encapsulate data provided from the upper layers into one or more Bluetooth frames or packets for transmission to the sink device 420 over the WPAN connection 430.

Communications may be target wake time (TWT)-based with synchronized end-to-end (E2E) timing. TWT involves the use of a schedule for waking up to communicate and powering down to conserve power.

As indicated above, FIG. 5 is provided as an example. Other examples may differ from what is described with regard to FIG. 5.

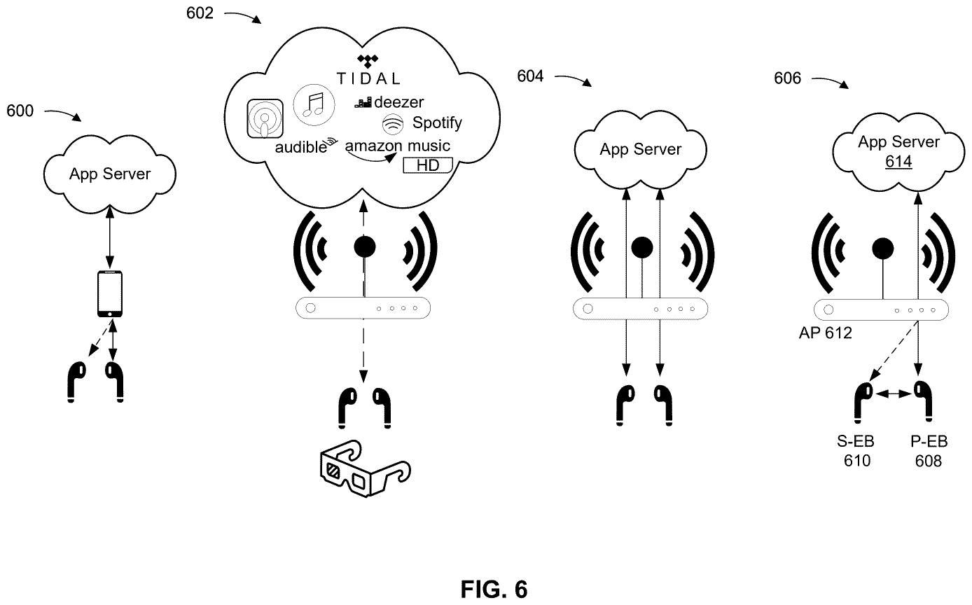

FIG. 6 is a diagram illustrating examples of a direct-to-cloud system, in accordance with the present disclosure.

In many scenarios, a personal device, such as earbuds, are connected to a companion device, such as a UE (e.g., phone, laptop), which is connected to an application server. The music or audio from the application server passes through the UE, as shown by example 600. However, in other scenarios, personal devices may have direct internet access with wireless connectivity, without dependency on a companion device. The personal devices may be built on IP-addressable and networkable audio products (e.g., earbuds/augmented reality (AR)/XR glasses) using low power WLAN (e.g., Wi-Fi) chips. As shown by example 602, the earbuds or glasses may connect to the application server via a Wi-Fi access point. A platform that enables service providers with direct consumer access enables new audio user experiences with high quality and tailored applications from service providers.

Example 604 shows a dual stream connection for left and right earbuds that each have a Wi-Fi chip (two Wi-Fi clients with two distinct MAC addresses). However, audio synchronization streams from the application server would not typically contain timing information, the bandwidth would double with two independent devices, and the applications server would typically send stereo packets. The application server would see two independent devices that use the same account/credentials, and there would be duplicate device identification and duplicate session authorization. As a result, more signaling resources are consumed than necessary.

According to various aspects described herein, a pair of personal devices (e.g., two earbuds, two temple components of an XR/AR glass) may have a single stream Wi-Fi connection directly to the cloud with selective relay. Example 606 shows that a primary earbud (P-EB) 608 may share its MAC and IP addresses with a secondary earbud (S-EB) 610 over a peer link. The P-EB 608 connects to the AP 612 with a single MAC/IP address. The P-EB 608 initiates connection to the application server 614, where only a single MAC/IP address is seen by the AP/cloud (only one earbud has a Wi-Fi chip). The audio stream may be sent to the common MAC/IP address. The P-EB 608 receives and acknowledges the data from the AP 612. The S-EB 610 operates in a sniffer mode, listening to packets destined to the common MAC/IP address. The S-EB 610 communicates missed packets to the P-EB 608, and the P-EB 608 selectively relays missed packets to the S-EB 610 over a peer link. By presenting a single MAC/IP address to the cloud for multiple devices (e.g., paired devices), the paired devices may conserve signaling resources.

The peer link may be a bud-to-bud relay link on wireless personal area network (WPAN) (e.g., BT 2.4 GHz/5 GHz/6 GHz or Wi-Fi 2.4 GHz/5 GHz/6 GHz). The personal device may support a Dual Band Simultaneous (DBS) or a High Band Simultaneous (HBS) connection. Concurrency handling may be used if the personal device supports a single radio.

As indicated above, FIG. 6 is provided as an example. Other examples may differ from what is described with regard to FIG. 6.

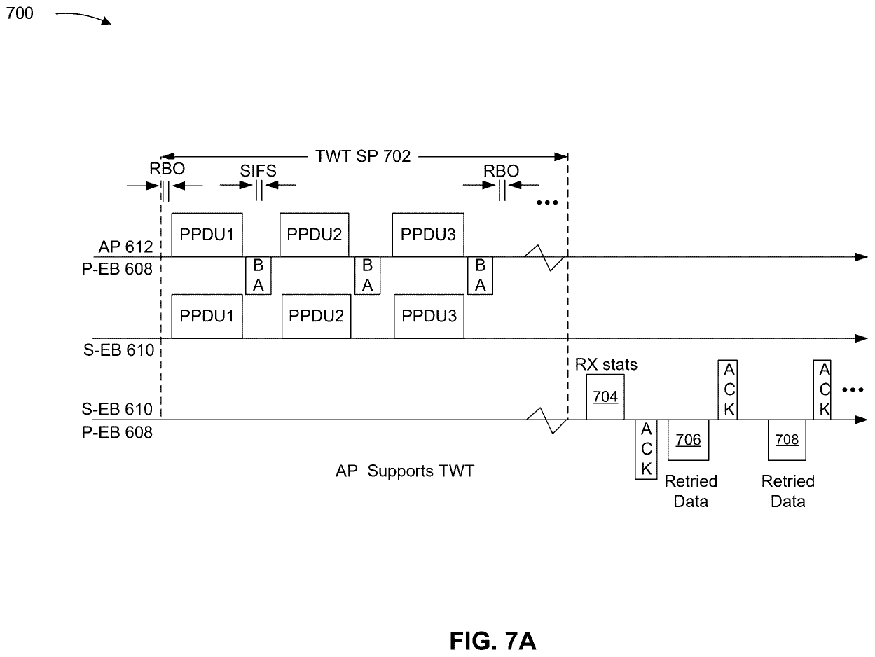

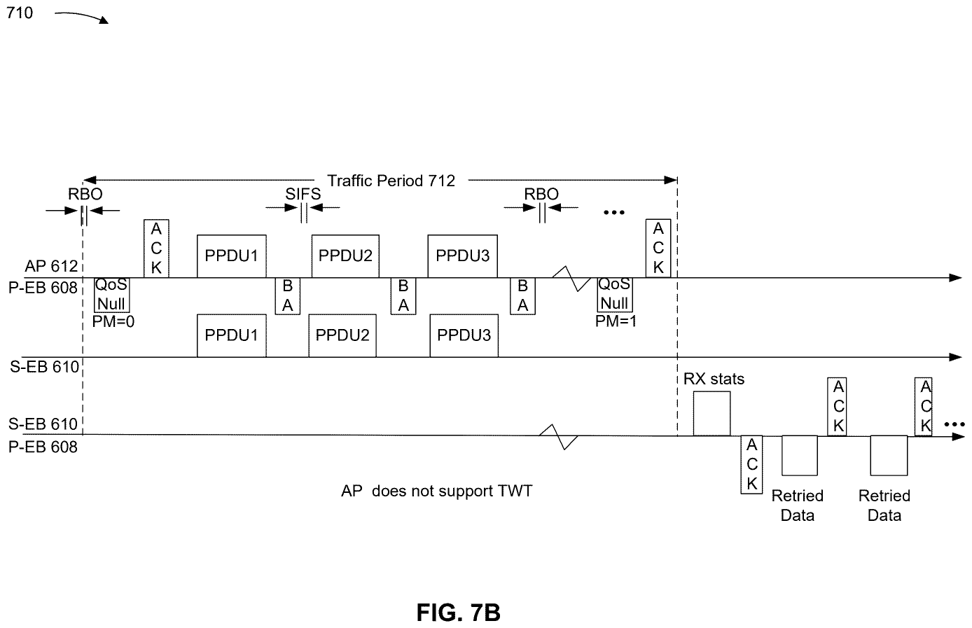

FIGS. 7A and 7B are diagrams illustrating examples of a single stream Wi-Fi connection for paired devices, in accordance with the present disclosure.

In some aspects, packets may be relayed at an end of a TWT service period (SP), such as TWT SP 702 in example 700 of FIG. 7A. An S-EB 610 may keep track of a MAC PDU (MPDU) reception statistics for the duration of P-EB 608 traffic with the AP 612. The TWT SP 702 (if the AP 612 supports TWT) may be a preconfigured maximum traffic period communicated between the two earbuds in advance. The TWT SP 702 may end upon receiving a PM=1 packet (packet mode) from the P-RB 608 to the AP 612. Example 710 of FIG. 7B shows a traffic period 712 if the AP 612 does not support TWT.

The P-EB 608 may acknowledge successfully received packets to the AP 612 after each physical layer convergence protocol data unit (PPDU) (e.g., PPDU1, PPDU2, PPDU3). There may be a ready before operation (RBO) time before a PPDU or a short interframe space (SIFS) between PPDUs. The P-EB 608 stores all packets until the end of the TWT SP 702 or traffic periodic 712. The S-EB 610 may share accumulated MPDU PPDU receive (Rx) stats 704 to the P-EB 608 over a peer link (e.g., BT 2G/5G/6G) at the end of the TWT SP 702. The Rx stats 704 may be communicated in the form of an Rx bitmap.

The relay may be over a Wi-Fi link or over a BT peer link. For a BT peer link, synchronization (SYNC) packets may be transmitted. The P-EB 608 may share all missed packets with the S-EB 610 over the peer link. The relay on the peer link is not overlapping with data transmission/reception. For Wi-Fi link, the P-EB 608 may operate as a soft AP and the S-EB 610 as a mobile station (STA).

Missed packets may be retried (706, 708) up to a preconfigured maximum number of retries on the peer link or up to a time-triggered protocol (TTP) of missed packets. The P-EB 608 may identify the intersection of the media packets that the S-EB 610 received and the media packets that the S-EB 610 missed and send the data to the S-EB 610. The P-EB 608 may need to send an explicit indication of what the P-EB 608 is sending to the S-EB 610 so that the latter does not continue to request the missed packets.

In some embodiments, the P-EB 608 may share its received bitmap first with the S-EB 610, and the S-EB 610 may identify the intersection of what the P-EB 608 received and what the S-EB 610 missed locally.

In some aspects, a relay link may involve a unidirectional selective relay. The P-EB 608 may buffer the packets that are successfully received by the P-EB 608. The S-EB 610 may inform the P-EB 608 of the packets the S-EB 610 missed. The P-EB 608 may calculate the intersection of the packets the P-EB 608 successfully received and the packets that the S-EB 610 missed. The P-EB 608 may relay those packets to the S-EB 610.

In some aspects, a relay link may involve a bi-directional selective relay. Both earbuds may buffer the packets that are successfully received. The S-EB 610 may inform the P-EB 608 of the packets that the S-EB 610 missed. The P-EB 608 may inform the S-EB 610 of the packets that the P-EB 608 missed. The P-EB or S-EB calculates the intersection of the packets that are successfully received and the packets that the other earbud missed. Each earbud relays those packets to the other earbud.

As indicated above, FIGS. 7A and 7B are provided as examples. Other examples may differ from what is described with regard to FIGS. 7A and 7B.

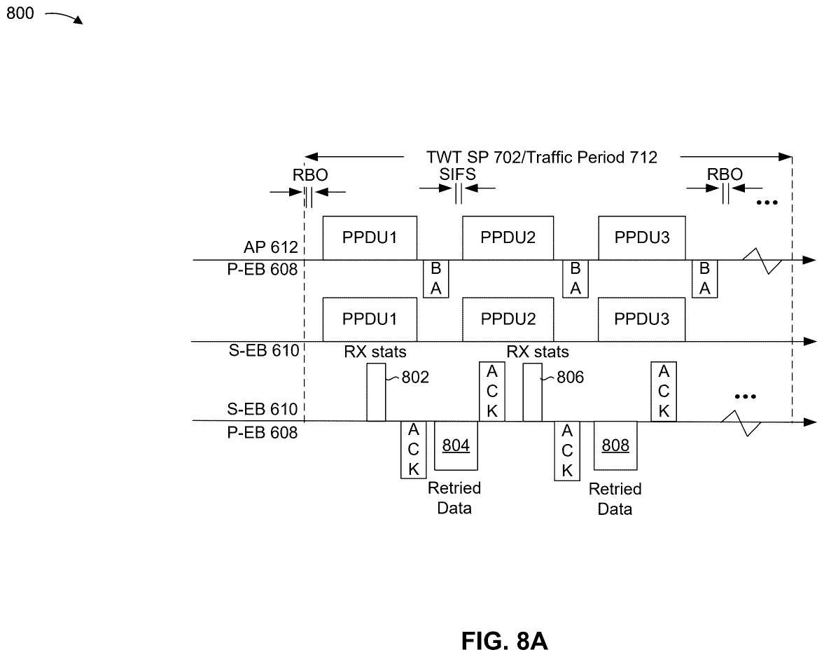

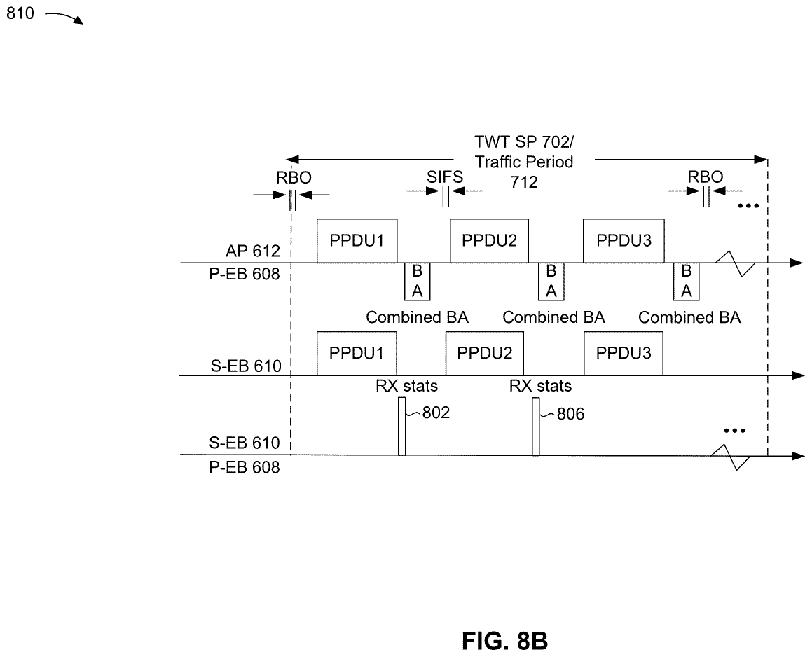

FIGS. 8A and 8B are diagrams illustrating examples of a single stream Wi-Fi connection for paired devices, in accordance with the present disclosure.

In some aspects, the S-EB 610 may share the Rx stats at the end of each PPDU (or a configured number of PPDUs) with the TWT SP 702 or the traffic period 712. Example 800 of FIG. 8A shows the S-EB 610 keeping track of MPDU Rx stats per PPDU (Rx stats 802, RX stats 806). The S-EB 610 shares the MPDU Rx stats to the P-EB 608 over a peer link (e.g., BT 2.4 GHz/5 GHz/ 6 GHz) at the end of each PPDU. The Rx stats may be communicated in the form of an Rx bitmap. For a BT peer link, the S-EB 610 may use a SYNC message to share the Rx stats.

The P-EB 608 may store received packets per PPDU (less memory impact, but tighter timeline constraint). The P-EB 608 acknowledges its successfully received packets to the AP 612 after each PPDU. The P-EB 608 drops the received packets by S-EB 610 from its buffer. At the end of the TWT SP 702/traffic period 712, the P-EB 608 shares all missed packets with the S-EB 610 over the peer link. The missed packets may be retried (804, 808) up to a preconfigured maximum number of retries on the peer link or up to a TTP of missed packets. That is, the retried data 804 and 808 is received within the TWT SP 702 or the traffic period 712.

Relay may overlap with data transmission or reception. Relay may be easier on an out-of-band BT (e.g., if Wi-Fi data is on 5G, relay can be on BT 2G or vice versa). The earbuds may define a relay piconet, where the missing packets are relayed from the P-EB 608 to the S-EB 610. For Bluetooth tethering Wi-Fi manager (TWM), this is aligned with the handset's Bluetooth piconet. For LE, this is offset from the connected isochronous stream (CIS) subevents by a couple of hundred μs.

Example 810 of FIG. 8B also shows Rx stats 802 and 806 that are provided at the end of each PPDU, in a combined acknowledgement (ACK) with no P-EB 608 relay of missed packets. The combined BA may be based at least in part on (e.g., a function of) the BA for the P-EB 608 and the Rx stats 806 from the S-EB 610. The combined BA may also be based at least in part on the request and/or an ACK from the S-EB 610. That is, the P-EB 608 may calculate the combined BA based at least in part on what the P-EB 608 received and what the S-EB 610 received. Also, there are no relayed packet in this approach from the first device to the second device No relay is required since the P-EB 608 acknowledges only the packets that were successfully received by both itself and the S-EB 610 to the AP 612 after each PPDU. The ACK may be a combined ACK, and the AP 612 may repeat those packets.

The P-EB 608 acknowledges only the packets that were successfully received by itself as well as the S-EB 610 (intersection) to the AP 612 after each PPDU (combined ACK). The P-EB 608 may not need to store any packets or relay any packets to the S-EB 610 over a peer link (which depends on the S-EB 610 directly receiving missed packets from the AP 612). Both earbuds are to ignore duplicate packets retried by the AP 612.

As indicated above, FIGS. 8A and 8B is provided as an example. Other examples may differ from what is described with regard to FIGS. 8A and 8B.

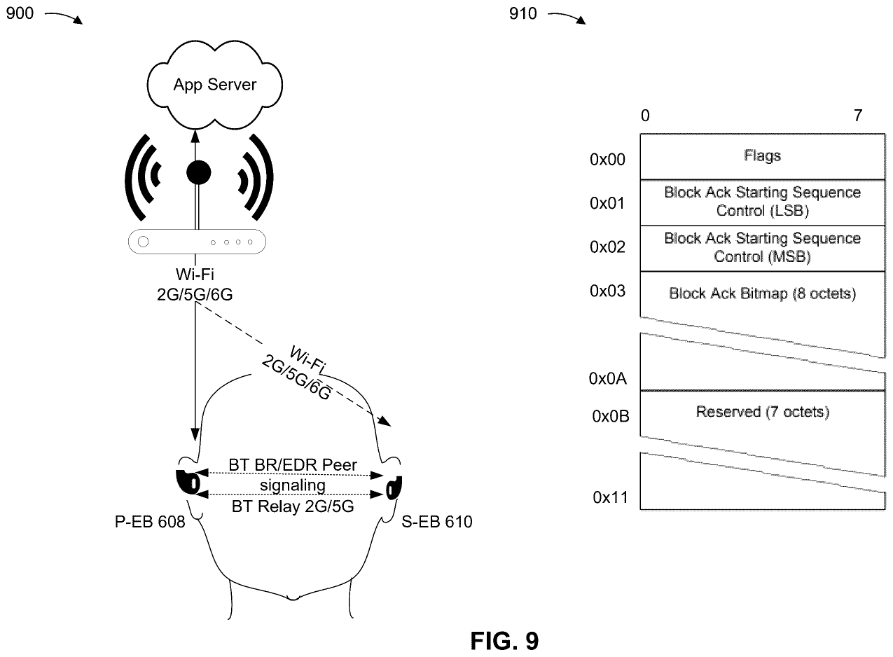

FIG. 9 is a diagram illustrating examples of relay link, in accordance with the present disclosure.

The relay link may include a BT relay piconet, as shown by example 900 in FIG. 9. The majority of relay piconet parameters may be based on the CP-SP (PEB-SEB) piconet. This is the PEB-SEB peer signaling link, which will be present even if the external audio source is a Wi-Fi only transport. The remaining relay piconet parameters in BT TWM may be derived from a Connected Central piconet (HS-PEB), which may not exist without a connected BT handset audio source. The relay piconet timing, baseband packet types, and maximum slots can be derived from the CP-SP piconet. The relay piconet physical channel's clock (CLK)=Connected Peripheral's CLK+Offset. The relay piconet may be used to carry SYNC packets and missed PPDUs. Missed PPDUs are identified using an LT_ADDR that is communicated by the Connected Peripheral to the Shadowing Peripheral via a quality of service (QoS) link management protocol (QLMP). The relay piconet inherits all the properties of the CP-SP piconet. The roles of the Connected Peripheral and Shadowing Peripheral on the Relay piconet are the same as their roles on the CP-CP piconet.

The relay link may include a Wi-Fi SYNC packet, as shown by example 910 in FIG. 9. The received and missed packets are specific to Wi-Fi, rather than existing BT specific relay SYNC packet formats. The packet type used for the SYNC packet is “FHS”. The FHS packet does not contain a payload header and has a fixed length of 18 bytes. For the relay link of FIG. 8B, the earbuds may use a standard 802.11 bitmap. The payload format for the SYNC packet by example 910.

For the solutions in FIGS. 7A and 7B, the earbuds may use a proprietary block ACK bitmap that describes a concatenated indication of received/missed packets relative to the 802.11 AP-STA sequence number. The length of this proprietary block ACK bitmap may be larger than the standard 802.11 bitmap, since this is reflecting the status of all packets received during the TWT SP 702/traffic periodicity 712 (concatenated BA bitmap). When roaming between APs of the 802.11 sequence number changes for a new AP, an earbud may provide Fa LUSH flag in the Wi-Fi SYNC packet to indicate reset of the bitmap relative to 802.11 sequence number of new AP.

As indicated above, FIG. 9 is provided as an example. Other examples may differ from what is described with regard to FIG. 9.

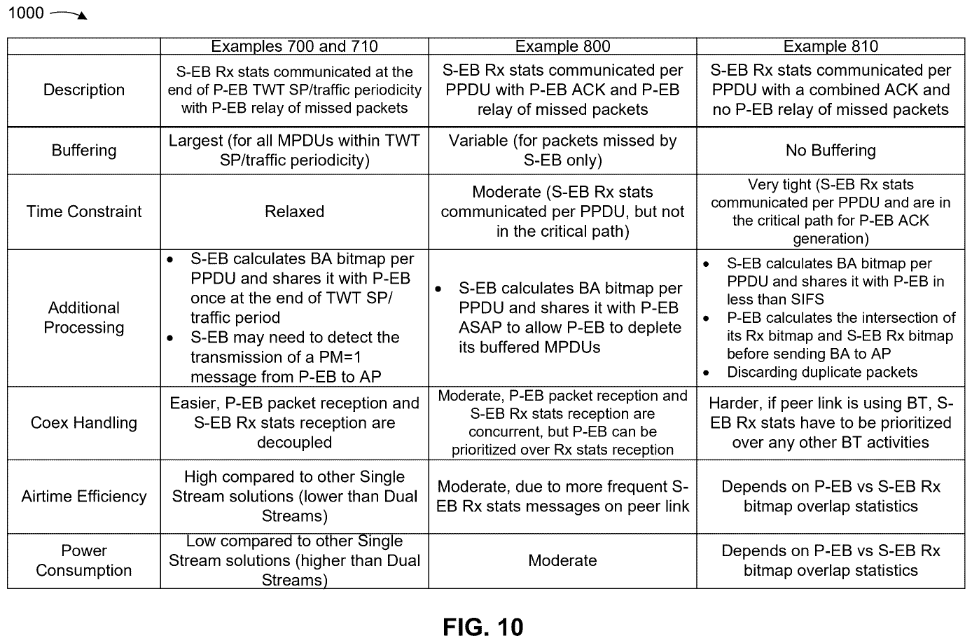

FIG. 10 is a diagram illustrating an example 1000 of characteristics of solutions, in accordance with the present disclosure.

Example 1000 reiterates that RX stats are communicated at the end of the TWT SP or traffic period with the P-EB relay of missed packets for examples 700 and 710, or communicated during the TWT SP or traffic period for example 800. For example 810, RX stats are communicated with a combined ACK and there are no P-EB relay of missed packets. There is more buffering of packets for examples 700 and 710 than for example 800. There is no buffering for example 810.

The time constraint for examples 700 and 710 are relaxed, while examples 800 and 810 have tighter time constraints. The table of example 1000 shows the calculation of a bitmap per PPDU for each example and how the examples work with coexistent technologies. Example 1000 also shows air time efficiency and power consumption for the examples.

As indicated above, FIG. 10 is provided as an example. Other examples may differ from what is described with regard to FIG. 10.

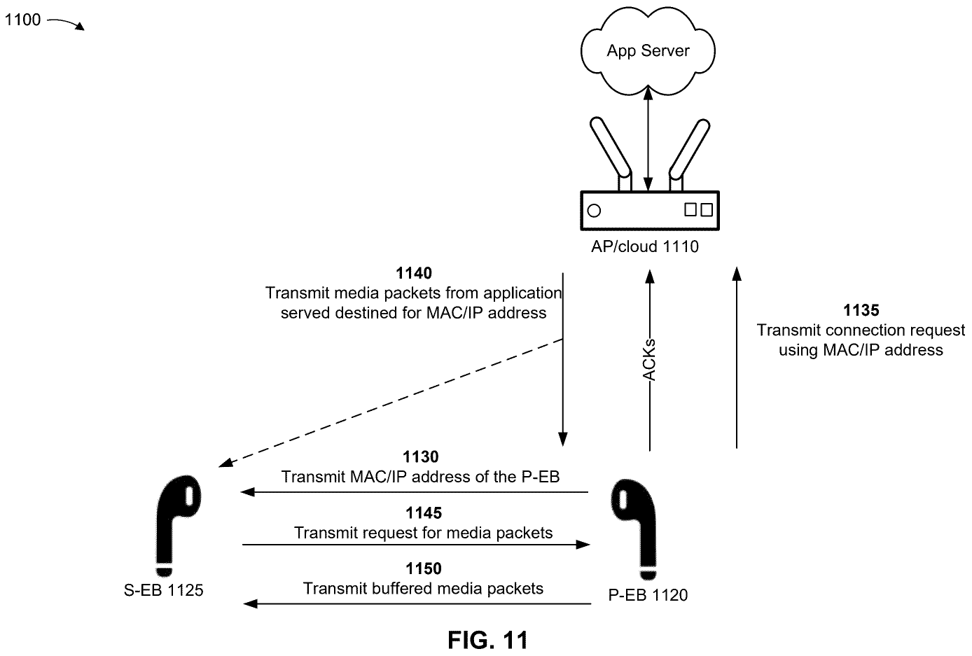

FIG. 11 is a diagram illustrating an example 1100 of a single stream connection to the cloud from paired devices, in accordance with the present disclosure. Example 1100 shows a first device, such as P-EB 1120 (e.g., P-EB 608, wireless communication device 200) that is paired with a second device, such as S-EB 1125 (e.g., S-EB 610, wireless communication device 200), and that communicates with an AP/cloud/application server 1110 (e.g., network entity).

P-EB 1120 may be selected as the primary W-Fi device. As shown by reference number 1130, the P-EB 1120 may transmit the MAC/IP address of the P-EB 1120 to the S-EB 1125 over a peer link, such that the S-EB 1125 can sniff or listen for media packets destined for the MAC/IP address. As shown by reference number 1135, the P-EB 1120 may transmit a connection request towards the cloud/application server via an AP using a single MAC/IP address of the P-EB 1120.

As shown by reference number 1140, the application server/cloud may transmit media packets via the AP to the P-EB 1120. The P-EB 1120 may receive media packets and the S-EB 1125 may sniff the media packets. The P-EB 1120 may buffer the media packets. The P-EB 1120 may transmit ACKs for the media packets that are successfully received.

As shown by reference number 1145, the S-EB 1125 may request from the P-EB 1120 any packets identified as being missed by the S-EB 1125. This request may be on the same technology (BT/Wi-Fi) as the connection between the AP and the P-EB 1120 or on an alternate technology and on the same band or a different band (2G, 5G, 6G). In some aspects, the request is at an end of a TWT or traffic period. In some aspects, the request is after each PPDU within the TWT or traffic period.

As shown by reference number 1150, the P-EB 1120 may transmit to the S-EB 1125 buffered media packets that were requested. This may include a selective relay of missed packets. Packet relay may be on the same technology (BT/Wi-Fi) as the connection between the AP and the P-EB 1120 or on an alternate technology (out-of-band) and on the same band or a different band (2G, 5G, 6G). In some aspects, both devices buffer may successfully receive packets and selectively relay missed packets by one device to the other device.

As indicated above, FIG. 11 is provided as an example. Other examples may differ from what is described with regard to FIG. 11.

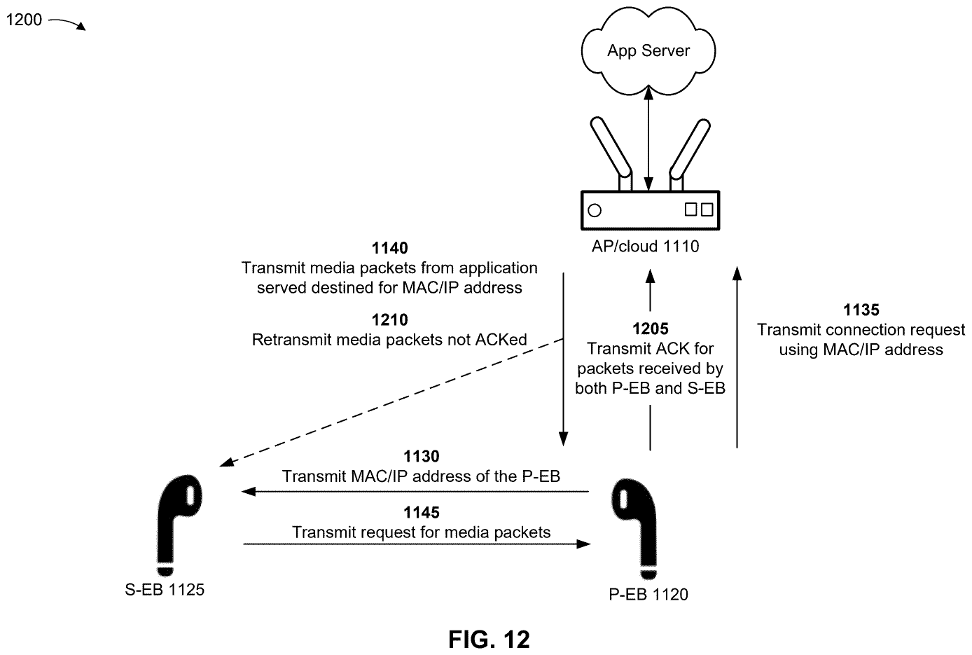

FIG. 12 is a diagram illustrating an example 1200 of a single stream connection to the cloud from paired devices, in accordance with the present disclosure.

In some aspects, such as for example 810, the P-EB 1120 does not transmit requested packets missed by the S-EB 1125. Instead, as shown by reference number 1205, the P-EB 1120 transmits an ACK for packets received by both the P-EB 1120 and the S-EB 1125. Therefore, packets not received by the S-EB 1125 are retransmitted by the application server itself, as shown by reference number 1210. No buffering by the P-EB 1120 is necessary. This conserves signaling resources and processing resources of the earbuds.

As indicated above, FIG. 12 is provided as an example. Other examples may differ from what is described with regard to FIG. 12.

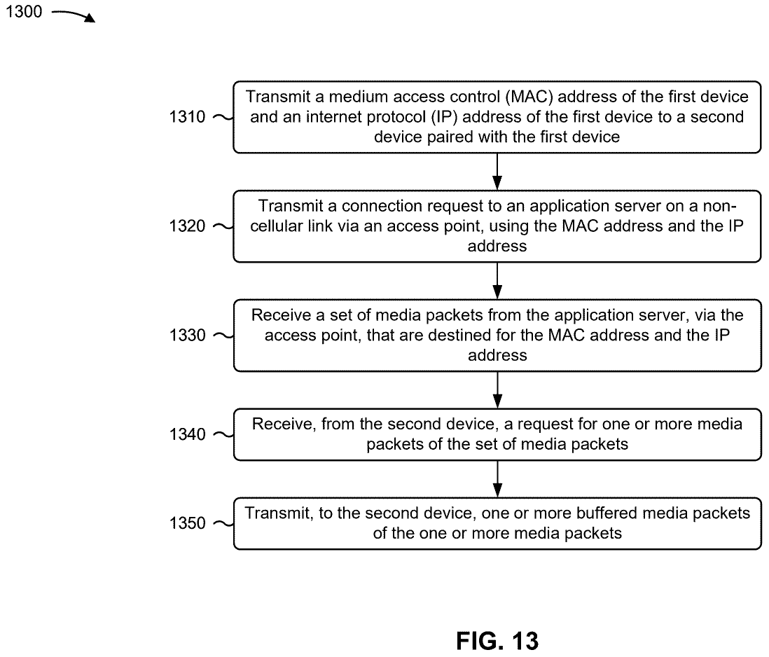

FIG. 13 is a diagram illustrating an example process 1300 performed, for example, at a first device or an apparatus of a first device, in accordance with the present disclosure. Example process 1300 is an example where the apparatus or the first device (e.g., wireless communication device 200, P-EB 1120) performs operations associated with single stream media connection from an AP for multiple devices, such as a pair of earbuds.

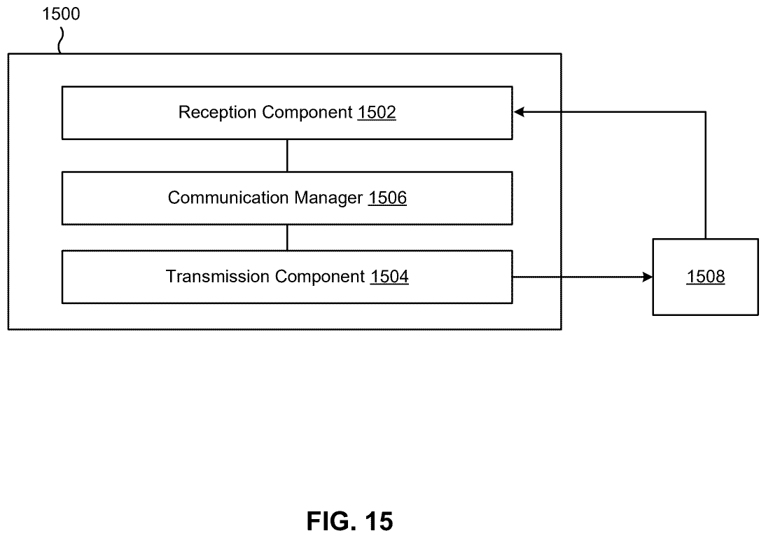

As shown in FIG. 13, in some aspects, process 1300 may include transmitting a MAC address of the first device and an IP address of the first device to a second device paired with the first device (block 1310). For example, the first device (e.g., using transmission component 1504 and/or communication manager 1506, depicted in FIG. 15) may transmit a MAC address of the first device and an IP address of the first device to a second device paired with the first device, as described above.

As further shown in FIG. 13, in some aspects, process 1300 may include transmitting a connection request to an application server on a non-cellular link via an access point, using the MAC address and the IP address (block 1320). For example, the first device (e.g., using transmission component 1504 and/or communication manager 1506, depicted in FIG. 15) may transmit a connection request to an application server on a non-cellular link via an access point, using the MAC address and the IP address, as described above.

As further shown in FIG. 13, in some aspects, process 1300 may include receiving a set of media packets from the application server, via the access point, that are destined for the MAC address and the IP address (block 1330). For example, the first device (e.g., using reception component 1502 and/or communication manager 1506, depicted in FIG. 15) may receive a set of media packets from the application server, via the access point, that are destined for the MAC address and the IP address, as described above.

As further shown in FIG. 13, in some aspects, process 1300 may include receiving, from the second device, a request for one or more media packets of the set of media packets (block 1340). For example, the first device (e.g., using reception component 1502 and/or communication manager 1506, depicted in FIG. 15) may receive, from the second device, a request for one or more media packets of the set of media packets, as described above.

As further shown in FIG. 13, in some aspects, process 1300 may include transmitting, to the second device, one or more buffered media packets of the one or more media packets (block 1350). For example, the first device (e.g., using transmission component 1504 and/or communication manager 1506, depicted in FIG. 15) may transmit, to the second device, one or more buffered media packets of the one or more media packets, as described above.

Process 1300 may include additional aspects, such as any single aspect or any combination of aspects described below and/or in connection with one or more other processes described elsewhere herein.

In a first aspect, process 1300 includes transmitting acknowledgements for the one or more media packets that are received by the first device.

In a second aspect, alone or in combination with the first aspect, process 1300 includes buffering the one or more media packets that are received by the first device, to obtain the one or more buffered media packets, during a TWT SP or a traffic period of the first device that includes multiple PPDUs.

In a third aspect, alone or in combination with one or more of the first and second aspects, receiving the request includes receiving the request at an end of the TWT SP or the traffic period on a relay link between the first device and the second device.

In a fourth aspect, alone or in combination with one or more of the first through third aspects, transmitting the one or more buffered media packets includes transmitting the one or more buffered media packets at an end of the TWT SP or the traffic period.

In a fifth aspect, alone or in combination with one or more of the first through fourth aspects, transmitting the one or more buffered media packets includes transmitting the one or more buffered media packets on the relay link.

In a sixth aspect, alone or in combination with one or more of the first through fifth aspects, process 1300 includes transmitting information about the one or more buffered media packets on the relay link.

In a seventh aspect, alone or in combination with one or more of the first through sixth aspects, process 1300 includes buffering the one or more media packets that are received by the first device, to obtain the one or more buffered media packets, during each PPDU of multiple PPDUs during a TWT SP or a traffic period of the first device.

In an eighth aspect, alone or in combination with one or more of the first through seventh aspects, receiving the request includes receiving the request at an end of each PPDU of the multiple PPDUs. In some aspects, process 1300 includes, at the end of each PPDU, removing buffered media packets that are not indicated by the request as being missed by the second device.

In a ninth aspect, alone or in combination with one or more of the first through eighth aspects, transmitting the one or more buffered media packets includes transmitting the one or more buffered media packets at the end of each PPDU, and where process 1300 includes receiving ACKs for the one or more buffered media packets that are transmitted.

In a tenth aspect, alone or in combination with one or more of the first through ninth aspects, transmitting the one or more buffered media packets includes transmitting the one or more buffered media packets at the end of the TWT SP or the traffic period.

In an eleventh aspect, alone or in combination with one or more of the first through tenth aspects, process 1300 includes transmitting an ACK for each media packet that is successfully received by both the first device and the second device, and the ACK may be based at least in part on one or more of the request, receive statistics from the second device, or an ACK of the second device.

In a twelfth aspect, alone or in combination with one or more of the first through eleventh aspects, transmitting the one or more buffered media packets includes transmitting the one or more buffered media packets over a relay piconet that is out-of-band of the one or more media packets that are being received via the AP.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

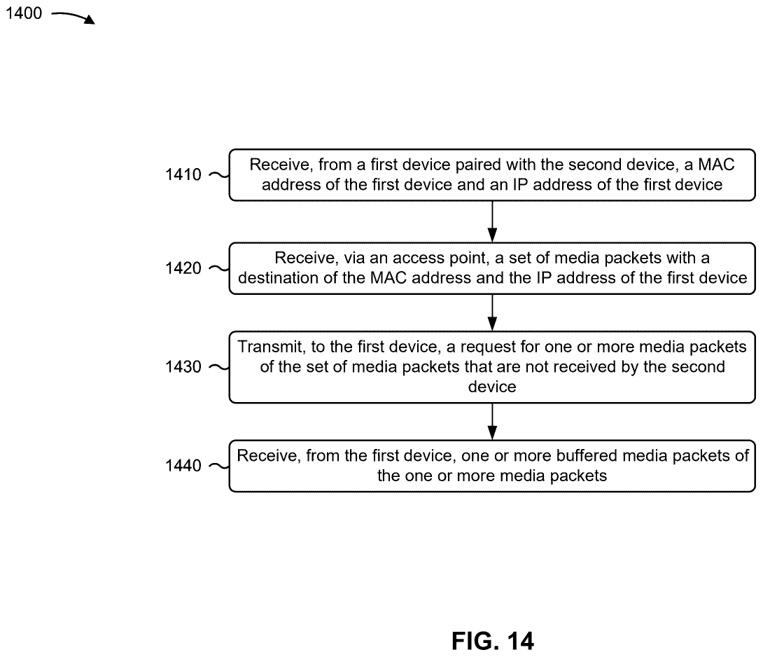

FIG. 14 is a diagram illustrating an example process 1400 performed, for example, at a second device or an apparatus of a second device, in accordance with the present disclosure. Example process 1400 is an example where the apparatus or the second device (e.g., wireless communication device 200, S-EB 610) performs operations associated with single stream media connection from an AP for multiple devices, such as a pair of earbuds. There may be other combinations of multiple peripheral devices that can operate with one MAC/IP address for a direct-to-cloud connection.

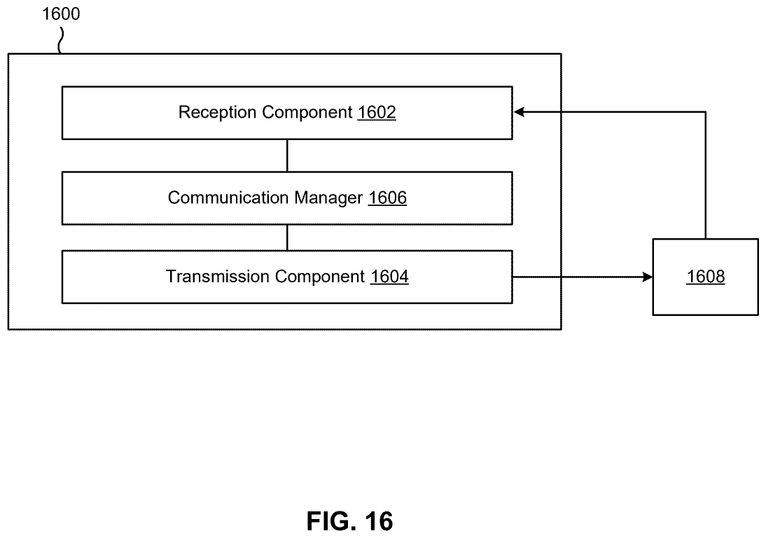

As shown in FIG. 14, in some aspects, process 1400 may include receiving, from a first device paired with the second device, a MAC address of the first device and an IP address of the first device (block 1410). For example, the second device (e.g., using reception component 1602 and/or communication manager 1606, depicted in FIG. 16) may receive, from a first device paired with the second device, a MAC address of the first device and an IP address of the first device, as described above.

As further shown in FIG. 14, in some aspects, process 1400 may include receiving, via an access point, a set of media packets with a destination of the MAC address and the IP address of the first device (block 1420). For example, the second device (e.g., using reception component 1602 and/or communication manager 1606, depicted in FIG. 16) may receive, via an access point, a set of media packets with a destination of the MAC address and the IP address of the first device, as described above.

As further shown in FIG. 14, in some aspects, process 1400 may include transmitting, to the first device, a request for one or more media packets of the set of media packets that are not received by the second device (block 1430). For example, the second device (e.g., using transmission component 1604 and/or communication manager 1606, depicted in FIG. 16) may transmit, to the first device, a request for one or more media packets of the set of media packets that are not received by the second device, as described above.

As further shown in FIG. 14, in some aspects, process 1400 may include receiving, from the first device, one or more buffered media packets of the one or more media packets (block 1440). For example, the second device (e.g., using reception component 1602 and/or communication manager 1606, depicted in FIG. 16) may receive, from the first device, one or more buffered media packets of the one or more media packets, as described above.

Process 1400 may include additional aspects, such as any single aspect or any combination of aspects described below and/or in connection with one or more other processes described elsewhere herein.

In a first aspect, the request is based at least in part on media packet reception statistics for the second device.

In a second aspect, alone or in combination with the first aspect, transmitting the request includes transmitting the request at an end of a TWT SP or a traffic period on a relay link between the first device and the second device.

In a third aspect, alone or in combination with one or more of the first and second aspects, transmitting the request includes transmitting the request at an end of each PPDU of multiple PPDUs of a TWT SP or a traffic period of the first device.

In a fourth aspect, alone or in combination with one or more of the first through third aspects, process 1400 includes transmitting, to the first device, ACKs for the one or more buffered media packets that are received by the second device.

In a fifth aspect, alone or in combination with one or more of the first through fourth aspects, transmitting the request includes transmitting the request over a relay piconet that is out-of-band of the one or more media packets that are being received via the AP.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a first device, or a first device may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 270 described in connection with FIG. 2. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system of the first device.

In some aspects, the apparatus 1500 may be configured to perform one or more operations described herein in connection with FIGS. 1-12. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the first device described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the first device described above in connection with FIG. 1, such as a radio, one or more RF chains, one or more transceivers, or one or more modems, each of which may in turn be coupled with one or more antennas of the first device.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components of the first device described above in connection with FIG. 1, such as a radio, one or more RF chains, one or more transceivers, or one or more modems, each of which may in turn be coupled with one or more antennas of the first device described in connection with FIG. 1. In some aspects, the transmission component 1504 may be co-located with the reception component 1502.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The transmission component 1504 may transmit a MAC address of the first device and an IP address of the first device to a second device paired with the first device. The transmission component 1504 may transmit a connection request to an application server on a non-cellular link via an access point, using the MAC address and the IP address. The reception component 1502 may receive a set of media packets from the application server, via the access point, that are destined for the MAC address and the IP address. The reception component 1502 may receive, from the second device, a request for one or more media packets of the set of media packets. The transmission component 1504 may transmit, to the second device, one or more buffered media packets of the one or more media packets.

The transmission component 1504 may transmit acknowledgements for the one or more media packets that are received by the first device. The communication manager 1506 may buffer the one or more media packets that are received by the first device, to obtain the one or more buffered media packets, during a target wake time (TWT) service period (SP) or a traffic period of the first device that includes multiple physical layer convergence protocol data units (PPDUs).

The transmission component 1504 may transmit information about the one or more buffered media packets on the relay link. The communication manager 1506 may buffer the one or more media packets that are received by the first device, to obtain the one or more buffered media packets, during each physical layer convergence protocol data unit (PPDU) of multiple PPDUs during a target wake time (TWT) service period (SP) or a traffic period of the first device. The transmission component 1504 may transmit an acknowledgement for each media packet that is successfully received by both the first device and the second device.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a second device, or a second device may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 270 described in connection with FIG. 2. As shown, the apparatus 1600 may communicate with another apparatus 1608, such as a UE or a network node (such as a CU, a DU, an RU, or a base station), using the reception component 1602 and the transmission component 1604. The communication manager 1606 may be included in, or implemented via, a processing system of the second device.

In some aspects, the apparatus 1600 may be configured to perform one or more operations described herein in connection with FIGS. 1-12. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the second device described in connection with FIG. 1. Additionally, or alternatively, one or more components shown in FIG. 16 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications, and may provide the processed signals to the one or more other components of the apparatus 1600. In some aspects, the reception component 1602 may include one or more components of the second device described above in connection with FIG. 1, such as a radio, one or more RF chains, one or more transceivers, or one or more modems, each of which may in turn be coupled with one or more antennas of the second device.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications, and may transmit the processed signals to the apparatus 1608. In some aspects, the transmission component 1604 may include one or more components of the second device described above in connection with FIG. 1, such as a radio, one or more RF chains, one or more transceivers, or one or more modems, each of which may in turn be coupled with one or more antennas of the second device described in connection with FIG. 1. In some aspects, the transmission component 1604 may be co-located with the reception component 1602.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The reception component 1602 may receive, from a first device paired with the second device, a MAC address of the first device and an IP address of the first device. The reception component 1602 may receive, via an access point, a set of media packets with a destination of the MAC address and the IP address of the first device. The transmission component 1604 may transmit, to the first device, a request for one or more media packets of the set of media packets that are not received by the second device. The reception component 1602 may receive, from the first device, one or more buffered media packets of the one or more media packets. The transmission component 1604 may transmit, to the first device, ACKs for the one or more buffered media packets that are received by the second device.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a first device, comprising: transmitting a medium access control (MAC) address of the first device and an internet protocol (IP) address of the first device to a second device paired with the first device; transmitting a connection request to an application server on a non-cellular link via an access point, using the MAC address and the IP address; receiving a set of media packets from the application server, via the access point, that are destined for the MAC address and the IP address; receiving, from the second device, a request for one or more media packets of the set of media packets; and transmitting, to the second device, one or more buffered media packets of the one or more media packets.

Aspect 2: The method of Aspect 1, further comprising transmitting acknowledgements for the one or more media packets that are received by the first device.

Aspect 3: The method of any of Aspects 1-2, further comprising buffering the one or more media packets that are received by the first device, to obtain the one or more buffered media packets, during a target wake time (TWT) service period (SP) or a traffic period of the first device that includes multiple physical layer convergence protocol data units (PPDUs).

Aspect 4: The method of Aspect 3, wherein receiving the request for the one or more media packets of the set of media packets includes receiving the request at an end of the TWT SP or the traffic period on a relay link between the first device and the second device.

Aspect 5: The method of Aspect 4, wherein transmitting the one or more buffered media packets includes transmitting the one or more buffered media packets at an end of the TWT SP or the traffic period.

Aspect 6: The method of Aspect 5, wherein transmitting the one or more buffered media packets includes transmitting the one or more buffered media packets on the relay link.

Aspect 7: The method of Aspect 5, further comprising transmitting information about the one or more buffered media packets on the relay link.

Aspect 8: The method of any of Aspects 1-7, further comprising buffering the one or more media packets that are received by the first device, to obtain the one or more buffered media packets, during each physical layer convergence protocol data unit (PPDU) of multiple PPDUs during a target wake time (TWT) service period (SP) or a traffic period of the first device.

Aspect 9: The method of Aspect 8, wherein receiving the request includes receiving the request at an end of each PPDU of the multiple PPDUs.

Aspect 10: The method of Aspect 9, further comprising, at the end of each PPDU, removing buffered media packets that are not indicated by the request as being missed by the second device.

Aspect 11: The method of Aspect 10, wherein transmitting the one or more buffered media packets includes transmitting the one or more buffered media packets at the end of each PPDU, and wherein the method includes receiving acknowledgements for the one or more buffered media packets that are transmitted.

Aspect 12: The method of Aspect 10, wherein transmitting the one or more buffered media packets includes transmitting the one or more buffered media packets at the end of the TWT SP or the traffic period.

Aspect 13: The method of Aspect 9, further comprising transmitting an acknowledgement for each media packet that is successfully received by both the first device and the second device, and wherein the acknowledgement is based at least in part on one or more of the request, receive statistics from the second device, or an acknowledgement of the second device.

Aspect 14: The method of Aspect 8, wherein transmitting the one or more buffered media packets includes transmitting the one or more buffered media packets over a relay piconet that is out-of-band of the one or more media packets that are being received via the access point.

Aspect 15: A method of wireless communication performed by a second device, comprising: receiving, from a first device paired with the second device, a medium access control (MAC) address of the first device and an internet protocol (IP) address of the first device; receiving, via an access point, a set of media packets with a destination of the MAC address and the IP address of the first device; transmitting, to the first device, a request for one or more media packets of the set of media packets that are not received by the second device; and receiving, from the first device, one or more buffered media packets of the one or more media packets.

Aspect 16: The method of Aspect 15, wherein the request is based at least in part on media packet reception statistics for the second device.

Aspect 17: The method of any of Aspects 15-16, wherein transmitting the request includes transmitting the request at an end of a target wake time service period or a traffic period on a relay link between the first device and the second device.

Aspect 18: The method of any of Aspects 15-17, wherein transmitting the request includes transmitting the request at an end of each physical layer convergence protocol data unit (PPDU) of multiple PPDUs of a target wake time service period or a traffic period of the first device.

Aspect 19: The method of any of Aspects 15-18, further comprising transmitting, to the first device, acknowledgements for the one or more buffered media packets that are received by the second device.

Aspect 20: The method of any of Aspects 15-19, wherein transmitting the request includes transmitting the request over a relay piconet that is out-of-band of the one or more media packets that are being received via the access point.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a first device, comprising:
one or more memories; and
one or more processors coupled to the one or more memories, the one or more processors individually or collectively configured to cause the first device to:
transmit a medium access control (MAC) address of the first device and an internet protocol (IP) address of the first device to a second device paired with the first device;
transmit a connection request to an application server on a non-cellular link via an access point, using the MAC address and the IP address;
receive a set of media packets from the application server, via the access point, that are destined for the MAC address and the IP address;
receive, from the second device, a request for one or more media packets of the set of media packets; and
transmit, to the second device, one or more buffered media packets of the one or more media packets.

2. The apparatus of claim 1, wherein the one or more processors are individually or collectively configured to cause the first device to transmit acknowledgements for the one or more media packets that are received by the first device.

3. The apparatus of claim 1, wherein the one or more processors are individually or collectively configured to cause the first device to buffer the one or more media packets that are received by the first device, to obtain the one or more buffered media packets, during a target wake time (TWT) service period (SP) or a traffic period of the first device that includes multiple physical layer convergence protocol data units (PPDUs).

4. The apparatus of claim 3, wherein to receive the request for the one or more media packets of the set of media packets, the one or more processors are individually or collectively configured to cause the first device to receive the request at an end of the TWT SP or the traffic period on a relay link between the first device and the second device.

5. The apparatus of claim 4, wherein to transmit the one or more buffered media packets, the one or more processors are individually or collectively configured to cause the first device to transmit the one or more buffered media packets at an end of the TWT SP or the traffic period.

6. The apparatus of claim 5, wherein to transmit the one or more buffered media packets, the one or more processors are individually or collectively are configured to cause the first device to transmit the one or more buffered media packets on the relay link.

7. The apparatus of claim 5, wherein the one or more processors are individually or collectively configured to cause the first device to transmit information about the one or more buffered media packets on the relay link.

8. The apparatus of claim 1, wherein the one or more processors are individually or collectively configured to cause the first device to buffer the one or more media packets that are received by the first device, to obtain the one or more buffered media packets, during each physical layer convergence protocol data unit (PPDU) of multiple PPDUs during a target wake time (TWT) service period (SP) or a traffic period of the first device.

9. The apparatus of claim 8, wherein to receive the request, the one or more processors are individually or collectively configured to cause the first device to receive the request at an end of each PPDU of the multiple PPDUs.

10. The apparatus of claim 9, wherein the one or more processors are individually or collectively configured to cause the first device to, at the end of each PPDU, remove buffered media packets that are not indicated by the request as being missed by the second device.

11. The apparatus of claim 10, wherein to transmit the one or more buffered media packets, the one or more processors are individually or collectively configured to cause the first device to transmit the one or more buffered media packets at the end of each PPDU, and wherein the one or more processors are individually or collectively configured to cause the first device to receive acknowledgements for the one or more buffered media packets that are transmitted.

12. The apparatus of claim 10, wherein to transmit the one or more buffered media packets, the one or more processors are individually or collectively configured to cause the first device to transmit the one or more buffered media packets at the end of the TWT SP or the traffic period.

13. The apparatus of claim 9, wherein the one or more processors are individually or collectively configured to cause the first device to transmit an acknowledgement for each media packet that is successfully received by both the first device and the second device, and wherein the acknowledgement is based at least in part on one or more of the request, receive statistics from the second device, or an acknowledgement of the second device.

14. The apparatus of claim 10, wherein to transmit the one or more buffered media packets, the one or more processors are individually or collectively configured to cause the first device to transmit the one or more buffered media packets over a relay piconet that is out-of-band of the one or more media packets that are being received via the access point.

15. An apparatus for wireless communication at a second device, comprising:
one or more memories; and
one or more processors coupled to the one or more memories, the one or more processors individually or collectively configured to cause the second device to:
receive, from a first device paired with the second device, a medium access control (MAC) address of the first device and an internet protocol (IP) address of the first device;
receive, via an access point, a set of media packets with a destination of the MAC address and the IP address of the first device;
transmit, to the first device, a request for one or more media packets of the set of media packets that are not received by the second device; and
receive, from the first device, one or more buffered media packets of the one or more media packets.

16. The apparatus of claim 15, wherein the request is based at least in part on media packet reception statistics for the second device.

17. The apparatus of claim 15, wherein to transmit the request, the one or more processors are individually or collectively configured to cause the second device to transmit the request at an end of a target wake time service period or a traffic period on a relay link between the first device and the second device.

18. The apparatus of claim 15, wherein to transmit the request, the one or more processors are individually or collectively configured to cause the second device to transmit the request at an end of each physical layer convergence protocol data unit (PPDU) of multiple PPDUs of a target wake time service period or a traffic period of the first device.

19. The apparatus of claim 15, wherein the one or more processors are individually or collectively configured to cause the second device to transmit, to the first device, acknowledgements for the one or more buffered media packets that are received by the second device.

20. The apparatus of claim 15, wherein to transmit the request, the one or more processors are individually or collectively configured to cause the second device to transmit the request over a relay piconet that is out-of-band of the one or more media packets that are being received via the access point.
